(19) United States
(12) Patent Application Publication
(10) Pub. No.: US 2018/0231487 A1
(43) Pub. Date: Aug. 16, 2018

(54) ELECTROANALYTICAL IMAGING METHODS AND DEVICES INVOLVING A SUBSTRATE WITH AN ARRAY OF ELECTRODES

(71) Applicant: UNIVERSITÉ LAVAL, Quebec (CA)

(72) Inventors: Amine MILED, Québec (CA); Jesse GREENER, Québec (CA); Adnane KARA, Québec (CA); Jessy MATHAULT, Longueuil (CA)

(21) Appl. No.: 15/891,797

(22) Filed: Feb. 8, 2018

Related U.S. Application Data
(60) Provisional application No. 62/457,528, filed on Feb. 10, 2017.

(51) Int. Cl. G01N 27/27; G01N 27/417; G01N 27/30; G01N 27/327

(52) U.S. Cl. CPC G01N 27/27; G01N 27/327; G01N 27/301; G01N 27/4175

(57) ABSTRACT

The electroanalytical imaging device generally has an electroanalytical cell having a substrate and an array of electrodes mounted on the substrate; an electroanalytical acquisition unit connected to the electrodes of the array and being configured for performing electroanalytical measurements between electrodes of the array; and a processor communicatively coupled to the electroanalytical acquisition unit. In some embodiments, the processor is configured for determining a proportion of the given electrode being covered by the analyte solution in a first electroanalytical measurement based on a first value of the first electroanalytical measurement and on a calibration value.

### FIELD

The improvements generally relate to the field of electroanalytical methods and more specifically relate to electroanalytical imaging methods.

### BACKGROUND

Electroanalytical methods allow studying of an analyte solution via electrical signals collected from electrodes in contact with the analyte solution.

For example, in one electroanalytical method, the electroanalytical measurements include a measurement of a current across the analyte solution via the electrodes. As can be understood, a solution having a higher concentration of analyte (conductive ions, for example) will tend to facilitate the current more than a solution having a lower or a null concentration of said analyte. Another class of electroanalytical methods, called potentiometric measurements, involves applying a known voltage across two electrodes (working electrode and counter electrode), relative to a third (reference electrode) and monitoring the resulting current. Here, analyte species capable of being electrically reduced or oxidized will cause an abrupt change in the current at a voltage specific to said redox molecule. The voltage at which this abrupt change in current occurs and the current value can be indicative of the type and concentration of the analyte redox molecules. Accordingly, the presence or the absence of the analyte solution across the electrodes can be determined based on such electroanalytical measurements.

Recently, electroanalytical devices have been used for imaging purposes. More specifically, these so-called electroanalytical “imaging” devices typically incorporate a substrate and an array of electrodes mounted on the substrate. By performing an electroanalytical measurement on all the electrodes, one can determine the presence or the absence of analyte solution at a position of each electrode and thus generate a digital image which maps the presence or the absence of analyte solution at the position of each electrode.

Although the existing electroanalytical imaging devices are satisfactory to a certain degree, there remains room for improvement, especially since their spatial resolution is limited to the number of electrodes of the array.

### SUMMARY

In some aspects, there are provided electroanalytical imaging methods and devices which can increase the spatial resolution of existing electroanalytical imaging devices without necessarily increasing the number of electrodes of the array. Indeed, it was found that a proportion of a given electrode being covered by a given analyte solution can be determined on the basis of a calibration step performed using a calibration analyte solution having a similar analyte and a similar concentration than that of the given analyte solution.

In accordance with one aspect, there is provided a computer-implemented method for determining a proportion of a given electrode being covered by an analyte solution having a given concentration using an electroanalytical imaging device having an array of electrodes including the given electrode, the computer-implemented method comprising the steps of: receiving a calibration value of a calibration electroanalytical measurement between the given electrode and at least one other electrode of the array when the given electrode is fully covered by a calibration analyte solution having the given concentration; receiving a first value of a first electroanalytical measurement between the given electrode and at least one other electrode of the array; and determining the proportion of the given electrode being covered by the analyte solution in the first electroanalytical measurement based on the first value and on the calibration value.

In accordance with another aspect, there is provided an electroanalytical imaging device comprising: an electroanalytical cell having a substrate and an array of electrodes mounted on the substrate; an electroanalytical acquisition unit connected to the electrodes of the array and being configured for performing electroanalytical measurements between electrodes of the array; and a processor communicatively coupled to the electroanalytical acquisition unit and being configured for receiving a calibration value of a calibration electroanalytical measurement between a given electrode of the array and at least one other electrode of the array when the given electrode is fully covered by a calibration analyte solution having a given concentration; receiving a first value of a first electroanalytical measurement between the given electrode and at least one other electrode of the array; and determining the proportion of the given electrode being covered by an analyte solution having the given concentration in the first electroanalytical measurement based on the first value and on the calibration value.

In accordance with another aspect, there is provided a computing device for use with an electroanalytical imaging device having an array of electrodes, the computing device comprising: one of i) a processor and a memory communicatively coupled to one another and ii) an electronic circuit; the one of i) and ii) being configured for receiving a calibration value of a calibration electroanalytical measurement between a given electrode of the array and at least one other electrode of the array when the given electrode is fully covered by a calibration analyte solution having a given concentration; receiving a first value of a first electroanalytical measurement between the given electrode and at least one other electrode of the array; and determining a proportion of the given electrode being covered by an analyte solution having the given concentration in the first electroanalytical measurement based on the first value and on the calibration value.

In accordance with another aspect, there is provided a modular electroanalytical imaging device comprising: a plurality of electroanalytical cells each having an array of electrodes; a plurality of electroanalytical acquisition modules including a substrate, a multiplexer subsystem mounted on the substrate, and a processor mounted on the substrate and communicatively coupled to the multiplexer subsystem, the multiplexer subsystem of at least one of the plurality of electroanalytical acquisition modules being connected to the electrodes of at least a corresponding one of the plurality of electroanalytical cells; a measurement subsystem communicatively coupled to the connected electrodes via the corresponding multiplexer subsystem of the at least one of the plurality of electroanalytical acquisition modules; and a computer communicatively coupled to at least one processor of the at least one of the plurality of electroanalytical acquisition modules and being configured to produce a digital image based on electroanalytical measurements performed by the measurement subsystem between the connected electrodes.

Many further features and combinations thereof concerning the present improvements will appear to those skilled in the art following a reading of the instant disclosure.

### DESCRIPTION OF THE FIGURES

In the figures,

FIG. 1 is a schematic view of an example of an electroanalytical imaging device, in accordance with an embodiment;

FIG. 2 is an oblique view of an electroanalytical cell of the electroanalytical imaging device of FIG. 1, in a calibration step, in accordance with an embodiment;

FIG. 2A is a sectional view of the electroanalytical cell of FIG. 2 taken along line 2A-2A of FIG. 2, in accordance with an embodiment;

FIG. 3 is an oblique view of the electroanalytical cell of the electroanalytical imaging device of FIG. 1, in a measurement step, in accordance with an embodiment;

FIG. 3A is a sectional view of the electroanalytical cell of FIG. 3 taken along line 3A-3A of FIG. 3, in accordance with an embodiment;

FIG. 4 is an oblique and exploded view of another example of an electroanalytical cell, shown with a container and a lid, in accordance with an embodiment;

FIG. 4A is a top plan view of the electroanalytical cell of FIG. 4, with an analyte solution on electrodes of the electroanalytical cell, in accordance with an embodiment;

FIG. 5 is a schematic view of an image generated based on electroanalytical measurements on the electrodes of the electroanalytical cell of FIG. 4A, in accordance with an embodiment;

FIG. 6 is an oblique view of another example of an electroanalytical cell, shown with a channel, in accordance with an embodiment;

FIG. 6A is a top plan view of the electroanalytical cell of FIG. 6, showing a flow of analyte solution and a flow of confinement solution flowing on electrodes of the electroanalytical cell, in accordance with an embodiment;

FIG. 7 is a schematic view of an image generated based on electroanalytical measurements on the electrodes of the electroanalytical cell of FIG. 6A, in accordance with an embodiment;

FIG. 8 is a schematic view of an example of another electroanalytical imaging device incorporating an electroanalytical cell with a microfluidic channel, in accordance with one embodiment;

FIG. 9 is a sectional view of an example of a substrate of an electroanalytical cell, showing conductors inside the substrate, in accordance with an embodiment;

FIG. 10 is a sectional view of an example of a substrate of the electroanalytical cell of FIG. 8, in accordance with an embodiment;

FIGS. 11A-12D are graphs showing data concerning cyclic voltammetry measurements as performed via the electroanalytical imaging device of FIG. 8, in accordance with an embodiment;

FIG. 13 is an example of an histogram showing calibration slopes associated with different electrodes of the electroanalytical cell of FIG. 8, in accordance with an embodiment;

FIG. 14A is an example of a raw digital image produced by the electroanalytical imaging device of FIG. 8 at given flow conditions, in accordance with an embodiment;

FIG. 14B is a smoothed version of the raw digital image of FIG. 14A, in accordance with an embodiment;

FIG. 14C is an optical image of the electroanalytical imaging device of FIG. 8 at the given flow conditions, in accordance with an embodiment;

FIG. 14D is a computer simulated image of the electroanalytical imaging device of FIG. 8 at the given flow conditions, in accordance with an embodiment;

FIG. 15 includes graphs showing smoothed versions of raw digital images produced by the electroanalytical imaging device of FIG. 8 at different flow conditions, in accordance with an embodiment;

FIG. 16A is a raw digital image produced by the electroanalytical imaging device of FIG. 8 at some flow conditions superimposed over a top plan view of the electroanalytical cell of FIG. 8, in accordance with an embodiment;

FIG. 16B is a graph showing cyclic voltammetry measurements taken with the electroanalytical imaging device of FIG. 8 in the flow conditions of FIG. 16A, in accordance with an embodiment;

FIG. 17A is a schematic and top plan view of the electroanalytical cell of FIG. 8, in accordance with an embodiment;

FIG. 17B is a graph showing a ratio of first measurement values I and a calibration value Imax as function of flow conditions, in accordance with an embodiment;

FIG. 17C is a graph showing an overlapping distance as function of the flow conditions for two different electrodes of the electroanalytical cell of FIG. 8, in accordance with an embodiment;

FIG. 18 includes schematic views showing computer simulated images of the electroanalytical cell of FIG. 8 at different flow conditions, in accordance with an embodiment;

FIG. 19 includes schematic views showing computer simulated images of a given electrode of the electroanalytical cell of FIG. 8 at the different flow conditions of FIG. 18, in accordance with an embodiment;

FIG. 20 is a schematic view of an example of a modular electroanalytical imaging device incorporating two electroanalytical cells connected to a respective one of two electroanalytical acquisition modules, in accordance with an embodiment;

FIG. 21 is a schematic view of a first example of a circuit connecting processors of the two different electroanalytical acquisition modules with an array of electrodes, in accordance with an embodiment;

FIG. 22 is a schematic view of a second example of a circuit connecting processors of the two different electroanalytical acquisition modules with an array of electrodes, in accordance with an embodiment; and

FIG. 23 is a schematic view of a hardware and software implementation of the modular electroanalytical imaging device of FIG. 20, in accordance with an embodiment.

### DETAILED DESCRIPTION

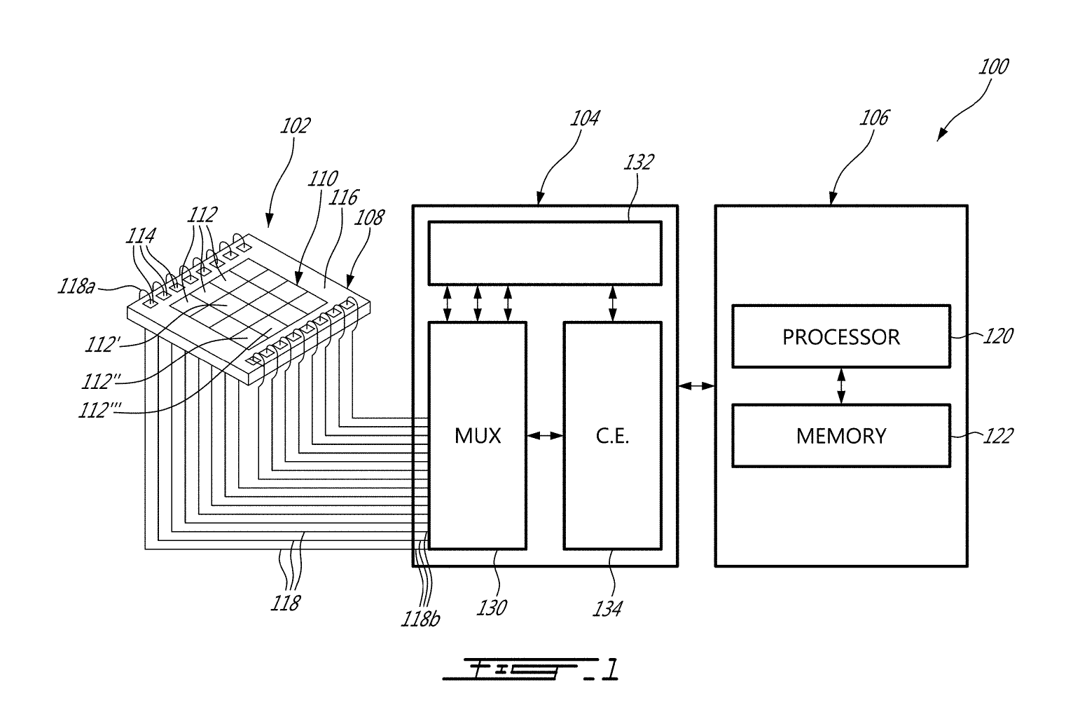

FIG. 1 shows an example of an electroanalytical imaging device 100, in accordance with an embodiment. As will be described, the electroanalytical imaging device 100 has an electroanalytical cell 102, an electroanalytical acquisition unit 104 and a computing device 106.

As depicted, the electroanalytical cell 102 has a substrate 108 and an array 110 of electrodes 112 mounted on the substrate 108. In this case, the electroanalytical cell 102 is provided in the form of a printed circuit board (PCB) wherein each of the electrodes is electrically connected to a respective conductive trace running inside the substrate 108 and which ends in a contact pad 114 accessible on a top surface 116 of the substrate 108.

As can be seen, the electroanalytical acquisition unit 104 is connected to the electrodes 112 of the array 110. To do so, a plurality of conductors 118 such as electrical wires or traces are used in this example to connect the electrodes 112 to the electroanalytical acquisition unit 104. More specifically, each conductor 118 has one end 118a which is wire-bonded to a respective one of the contact pads 114 and another end 118b which is connected to the electroanalytical acquisition unit 104.

The electroanalytical acquisition unit 104 is also configured for performing electroanalytical measurements between electrodes 112 of the array 110, as will be described in fuller detail below.

As shown, the computing device 106 is communicatively coupled to the electroanalytical acquisition unit 104 so that it can store and/or process the result of the electroanalytical measurements as they are measured by the electroanalytical acquisition unit 104. The communication between the computing device 106 and the electroanalytical acquisition unit 104 can be wired or wireless, depending on the embodiment. In this example, the computing device 106 has a processor 120 and a memory 122 communicatively coupled to one another. In some embodiments, the processor 102 is provided in the form of a field-programmable gate array (FPGA) whereas it can also be provided in the form of a microcontroller or any suitable type of processor in some other embodiments. It is intended that the computing device can also be provided in the form of an electrical circuit suitably designed to process the result of the electroanalytical measurements as they are received from the electroanalytical acquisition unit 104.

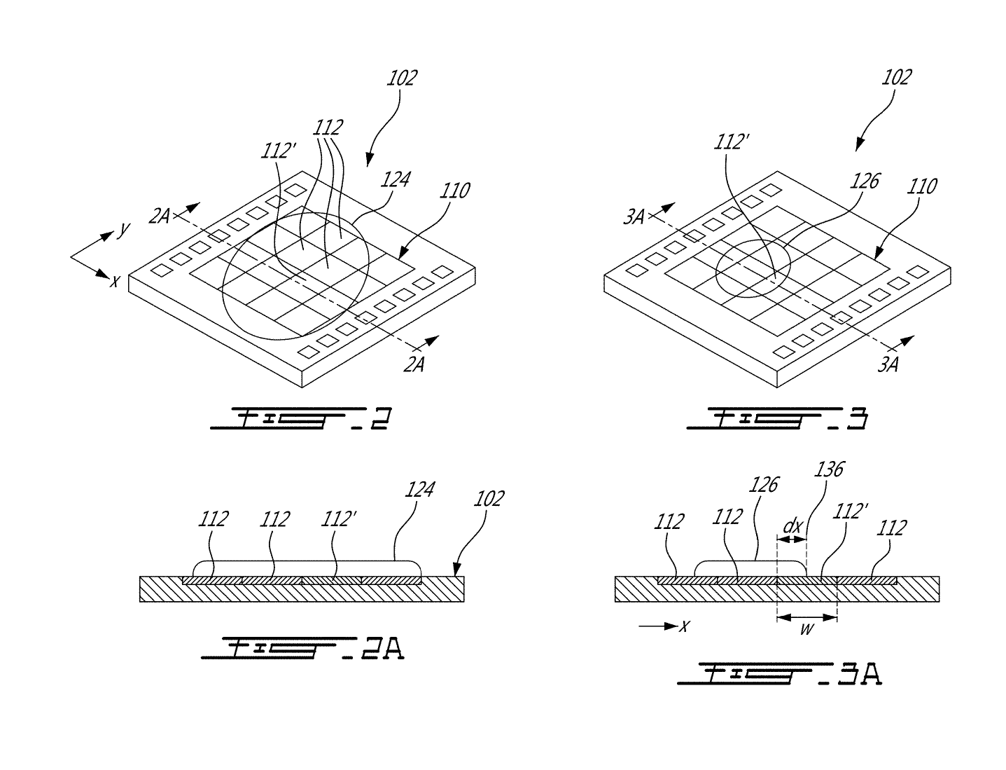

Broadly stated, the computing device 106 is configured to perform a method which can determine a proportion of any given electrode 112′ of the array 110 being covered by an analyte solution of a given concentration C. For ease of reading, the method will be described with reference to FIG. 1 as well as FIGS. 2-2A and FIGS. 3-3A which follow.

In a calibration step, depicted in FIGS. 2 and 2A, the computing device 106 receives a calibration value Vc of a calibration electroanalytical measurement between the given electrode 112′ of the array 110 and at least one other electrode 112 of the array 110 when the given electrode 112′ is fully covered by a calibration analyte solution 124 having the given concentration C. Indeed, FIGS. 2 and 2A show the electroanalytical cell 102 wherein a given quantity of the calibration analyte solution 124 has been deposited or flowed onto the array 110 such that the calibration analyte solution 124 fully covers the given electrode 112′ as well as other electrodes 112 of the array 110.

In a measurement step, depicted in FIGS. 3 and 3A, the computing device 106 receives a first value V1 of a first electroanalytical measurement between the given electrode 112′ and at least one other electrode 112 of the array 110. At this point, it is unknown to which extent the given electrode 112′ is covered by an analyte solution 126 having a concentration C′ substantially similar to the given concentration C of the calibration analyte solution 124, i.e. C≈C′. The given electrode 112′ can be fully covered by the analyte solution 126, not covered at all by it or anywhere in-between. The other electrode 112 used in this measurement step can be the same as the one used in the calibration step. Moreover, the order between calibration step and measurement step can inversed. Indeed, in some embodiment, the measurement step can be performed prior to the calibration step.

In a determination step, the computing device 106 determines the proportion of the given electrode 112′ being covered by the analyte solution 126 in the first electroanalytical measurement based on the first value V1 and on the calibration value Vc.

For instance, in an embodiment wherein the proportion is given by a ratio R of the first value V1 over the calibration value Vc, i.e. R=V1/Vc, the determined proportion is 1 when the first value V1 equals the calibration value Vc (i.e. when V1=Vc) and the determined proportion is 0 when the first value V1 is null (i.e. when V1=0). In other words, 100% of the given electrode is covered by the analyte solution when the first value V1 equals the calibration value Vc. In contrast, none of the given electrode is covered by the analyte solution when the first value V1 is null.

In the illustrated example, one can expect the first value V1 to be about half the calibration value Vc. Indeed, since the analyte solution 126 shown in FIGS. 3-3A can offer about half the electrical conductivity (or electrical charges) to the given electrode 112′ than the electrical conductivity (or electrical charge) that are offered by the calibration analyte solution 124 to the given electrode 112′ shown in FIGS. 2-2A. Accordingly, the ratio of the first value V1 over the calibration value Vc can substantially correspond to about 0.5 or 50% in this case. As can be understood, the spatial resolution that can be achieved using such method is not limited by the number of electrodes 112 of the array 110. It can rather be limited by the precision of the electroanalytical measurements.

The computing device 106 can repeat the receiving and determining steps with different electrodes 112 adjacent the given electrode 112′, thus obtaining a plurality of proportions at which respective ones of the plurality of electrodes 112 adjacent the given electrode 112′ are covered by the analyte solution. The computing device 106 can thus generate a digital image based on the plurality of determined proportions. In some embodiments, at each electroanalytical measurement, the computing device receives an identifier (e.g., coordinates) identifying which one of the electrodes 112 the corresponding electroanalytical measurement is associated with. Based on such identifiers, the computing device can generate a digital image showing which one of the electrodes are fully covered by the analyte solution, which one of the electrodes are only partially covered by the analyte solution and which one of the electrodes are not covered by the analyte solution.

The type of electroanalytical measurement that can be performed by the electroanalytical acquisition unit 104 can differ from one embodiment to another. For instance, the electroanalytical measurements can also be one or a combination of open circuit potential measurements, capacitance measurements, impedance measurements, bulk electrolysis measurements, voltammetry measurements including but not limited to linear sweep voltammetry, staircase voltammetry, differential pulse voltammetry, square wave voltammetry, normal pulse voltammetry, stripping voltammetry, square wave stripping voltammetry, and/or differential pulse stripping voltammetry, chronopotentiometry measurements including but not limited to ramp chronopotentiometry, staircase chronopotentiometry, and/or cyclic step chronopotentiometry, chronoamperometry measurements including but not limited to double step chronoamperometry, and/or cyclic step chronoamperometry, and/or electrochemical impedance spectroscopy measurements.

For instance, in the case where the electroanalytical measurements are open circuit potential measurements, such as shown in FIG. 1, the electroanalytical acquisition unit 104 includes a multiplexer subsystem 130 which is connected to the electrodes 112 of the array 110 via the conductors 118, a measurement subsystem 132 such as a voltmeter subsystem connected to the multiplexer subsystem 130, and control electronics 134 for controlling the multiplexer subsystem 130 and the measurement subsystem 132.

In one open circuit potential measurement, the electroanalytical acquisition unit 104 selects one working electrode 112′ and one reference electrode 112″ among the electrodes 112 of the array 110 via the multiplexer subsystem 130 and measures the electric potential between the working electrode 112′ and the reference electrode 112″ using the measurement subsystem 132. In this specific example, the calibration value Vc is the result of the open circuit potential measurement made across the working electrode 112′ and the reference electrode 112″ when a calibration analyte solution fully covers the working electrode 112′ in the calibration step. Still in this specific example, the first value V1 is the result of the open circuit potential measurement made across the working electrode 112′ and the reference electrode 112″ in the measurement step.

In the case where the electroanalytical measurements are cyclic voltammetry measurements, the measurement subsystem 132 of the electroanalytical imaging device 100 can be a potentiostat subsystem.

In one cyclic voltammetry measurement, the electroanalytical acquisition unit 104 selects one working electrode 112′, one reference electrode 112″ and one counter electrode 112′″ among the electrodes 112 of the array 110 via the multiplexer subsystem 130. Using the measurement subsystem 132, the electric potential of the working electrode 112′ is then ramped linearly versus time from an initial potential to a maximal potential and then ramped back in the opposite direction to return to the initial potential. A plurality of cycles of ramps in potential can be deemed necessary. Still using the measurement subsystem 132, the potential is measured between the working electrode 112′ and the reference electrode 112″, and the current is measured between the working electrode 112′ and the counter electrode 112′″ during the cycle(s) of ramp in potential. The cyclic voltammetry measurement yields a cyclic voltammogram trace which shows the current at the working electrode 112′ versus the potential of the working electrode 112′. The resulting electroanalytical curve is referred to as a “voltammogram trace” and is characteristic of the working electrode 112′. In this case, a maximal value of the voltammogram trace measured in the calibration step is assigned as the calibration value and a maximal value of the voltammogram trace measured in the measurement step is assigned as the first value.

The first value V1 is what characterizes the given electrode 112′ of the array 110 during the measurement step. To characterize other electrodes 112 of the array 110, the electroanalytical acquisition unit 104 simply selects another electrode 112 of the array as the working electrode 112′ and performs another electroanalytical measurement with the new selection of working, reference and counter electrodes 112′, 112″ and 112″. The reference and the counter electrodes 112″ and 112′″, if used, are preferably the same electrodes 112 from one cyclic voltammetry measurement to another.

In this embodiment, the array 110 is a two-dimensional array 110 of Nx times Ny electrodes 112, wherein both Nx and Ny is 4, for a total of sixteen electrodes. Accordingly, with three electrodes system with respect with cyclic voltammetry measurements, a total of 16−2=14 cyclic voltammetry measurements can be performed taking in consideration that 2 electrodes, the reference electrode 112″ and the counter electrode 112″, may not be used as working electrodes 112′. The illustrated example is not meant to be limiting. Indeed, in other embodiments, the array 110 can have any number (e.g., 2, 4, 16, 32, 64, 128, 256, . . . ) of electrodes as deemed suitable for a particular application.

The illustrated example shows that the electrodes are contiguous to one another. However, it is understood that the electrodes of the array can be spaced from one another in some other embodiments. For instance, the electrodes can be spaced from one another along the x-axis and contiguous to one another along the y-axis, or vice versa. Alternately, the electrodes can be spaced from one another along both the x- and y-axes.

In this example, the electrodes are coplanar with the top surface of the substrate. However, it will be understood that, in some other embodiments, the electrodes can be recessed from the top surface of the substrate or that the electrodes can protrude from the top surface of the substrate in alternate embodiments.

Referring back to FIG. 3A, one can see that the given electrode 112′ has a width w along the x-axis. In an embodiment where it can be assumed that a boundary 136 of a sample of the analyte solution 126 is substantially perpendicular to the width w or to the x-axis, an overlap distance dx can be determined further based on the given concentration C and on the known width of the given electrode 112′. Indeed, it was found that the overlap distance dx can be given by the relation: dx=A·Vc/V1 wherein A is a constant that depends on the given concentration C and on the width W of the given electrode 112′, Vc is the calibration value taken in the calibration step and V1 is the first value V1 taken during the measurement step. In at least some embodiments, it was shown that the constant A is given by: A=w/C.

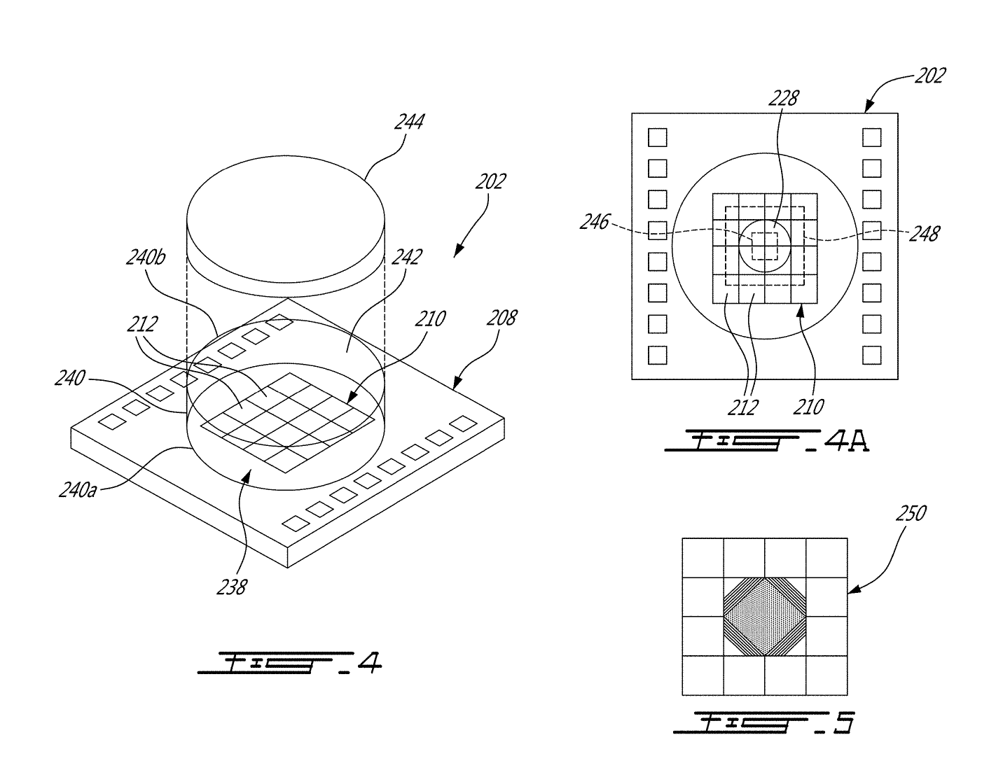

FIG. 4 shows another example of an electroanalytical cell 202, in accordance with a static flow embodiment. As depicted, the electroanalytical cell 202 has a substrate 208 and an array 210 of electrodes 212 mounted on the substrate 208. In this specific example, a container 238 is provided to the electroanalytical cell 202 for containing at least the analyte solution. As shown, the container 238 has a wall 240 with a bottom edge 240a sealingly mounted to the substrate 208 such as to expose the array 210 of electrodes 212. The wall 240 has a top edge 240b, opposite to the bottom edge 240a in this example, which defines an opening 242 leading to the exposed array 210 of electrodes 212. In this way, a lid 244 can be provided to couple to the top edge 240b of the wall 240 for closing the opening 242. In some embodiments, the container 238 can be provided in a form similar to that of a Petri dish, only mounted on the substrate 208 of the electroanalytical cell 202.

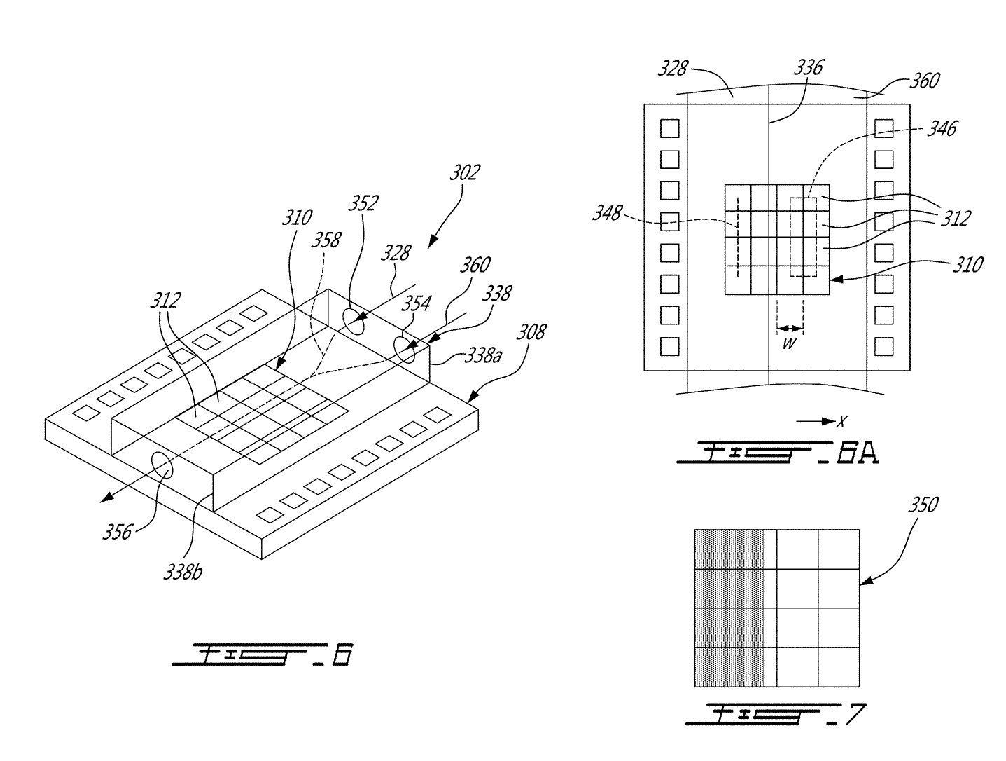

FIG. 4A shows a top plan view of the electroanalytical cell 202 of FIG. 4, only with a sample of an analyte solution 228 provided on top of the array 210 of electrodes 212. In this specific example, a conventional electroanalytical imaging device can be able to determine a presence of the analyte solution 228 on the 4 middle electrodes marked by dashed line 246 and an absence of the analyte solution 228 on the 12 periphery electrodes marked by dashed line 248. However, by performing the method described above with respect to all possible electrodes 212 of the array 210, the computing device can determine that the proportion of the 12 periphery electrodes 112 being covered by the analyte solution 228 is 0 and that the proportion of the 4 middle electrodes 112 being covered by the analyte solution 228 is about 75%. Accordingly, as best seen in FIG. 5, the computing device can generate an image 250 in which the 12 periphery electrodes are covered by the analyte solution 228 at a proportion of 0 and in which the 4 middle electrodes are covered by the analyte solution 228 at a proportion of about 75%. In some embodiments, the computing device can even generate an image in which the middle electrodes, i.e. the ones covered at 75% by the analyte solution 228, are covered with a surface which makes the interface between the coverage of each one of the middle electrodes in a single and continuous manner, e.g., a circle.

FIG. 6 shows another example of an electroanalytical cell 302, in accordance with a dynamic flow embodiment. As illustrated, the electroanalytical cell 302 has a substrate 308 and an array 310 of electrodes 312 mounted on the substrate 308. In this embodiment, a container such as channel 338 is provided to the electroanalytical cell 302 for allowing a flow of analyte solution over the array 310 of electrodes 312. In this example, the channel 338 has first and second inlets 352 and 354 at a first end 338a of the channel 338 and an outlet 356 at an opposite, second end 338b of the channel 338. In this way, the channel 338 defines a fluid path 358 extending between the first and second inlets 352 and 354 and the outlet 356. The channel 338 can have only one inlet, or more than two inlets in alternate embodiments.

In this example, an analyte solution 328 is flowed, at a first flow, from the first inlet 352 towards the outlet 356 while a confinement solution 360 is flowed, at a second flow from the second inlet 354 towards the outlet 356. In this way, the analyte solution 328 and the confinement solution 360 flow alongside each other. A steady state can occur when the first and second flows are constant along enough so that the transitory flow effects are dissipated. In such a steady state, a boundary 336 can be formed between the flow of the analyte solution 328 and the flow of the confinement solution 360, as best seen in FIG. 6A. Since a confinement solution 360 typically has a null concentration of analyte, e.g., distilled water or air.

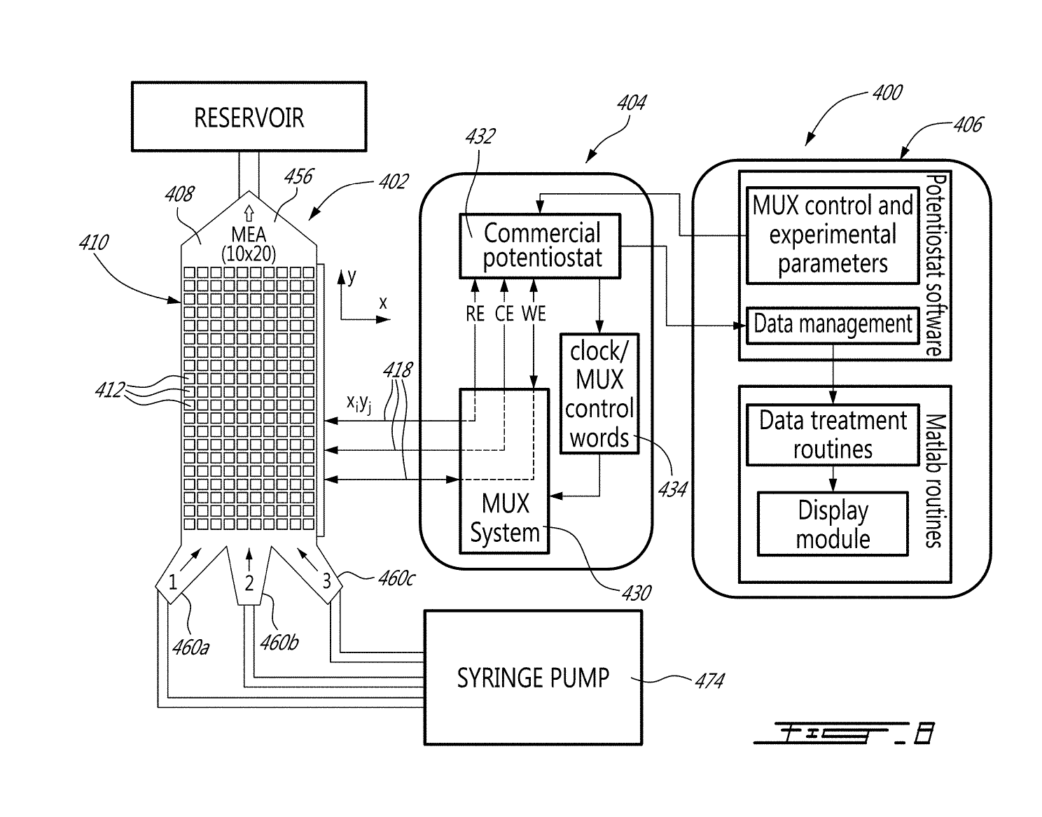

In this example, it can be assumed that the boundary 336 extends perpendicularly to the width w of the electrodes along the x-axis. Accordingly, when analytical measurements are performed for each electrode 312 of the array 310, the computing device can determine the proportion of coverage associated with each electrode 312. More specifically, the computing device can determine that the proportion of the right-hand side electrodes marked by dashed line 346 being covered by the analyte solution 328 is 0%, that the proportion of the left-hand side electrodes marked by dashed line 348 being covered by the analyte solution 328 is 100%, that the proportion of the remaining electrodes being covered by the analyte solution 328 is about 70%. In this embodiment, the computing device can generate an image 350 such as shown in FIG. 7 on the basis of the determined proportions. Indeed, since the computing device can identify that the proportions of the left-hand side electrodes are 100%, the image 350 shows that the left-hand side electrodes are covered by the analyte solution 328. In a similar manner, the computing device can identify that the proportions of the right-hand side electrodes are 0% such that the image 350 shows that the right-hand side electrodes are not covered by the analyte solution 328. Finally, the computing device can identify that the proportions of the middle electrodes are 70% such that the image 350 shows that the middle-electrodes are only partially covered by the analyte solution 328, and that the analyte solution 328 should be shown adjacent the left-hand side electrodes.

### Example 1—Electrochemical Imaging for Microfluidics: A Full System Approach

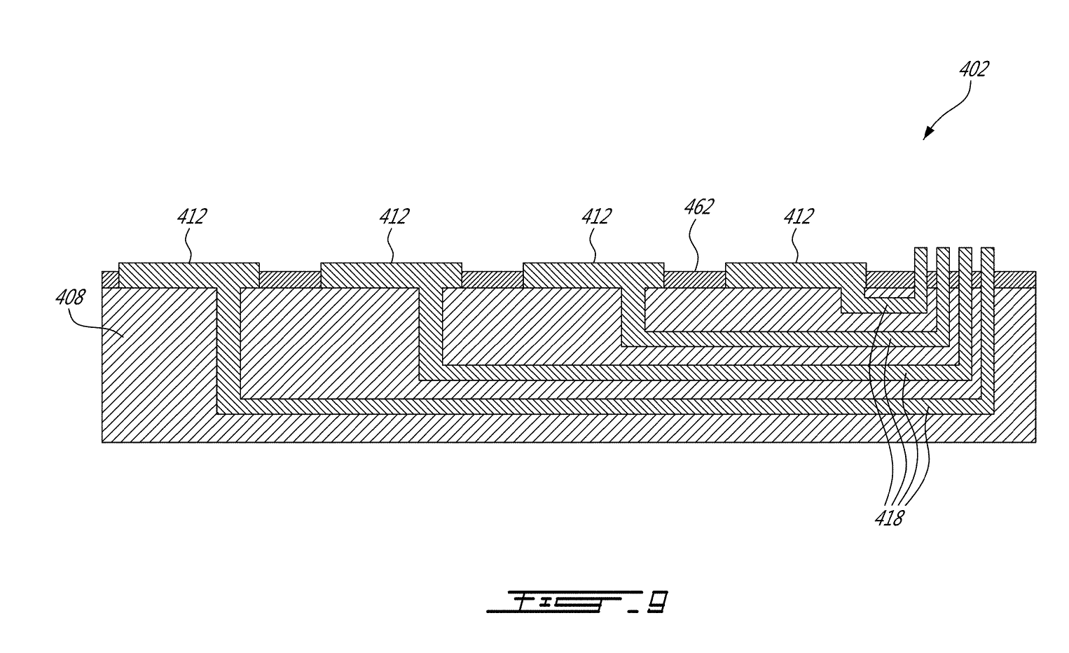

FIG. 8 shows an example of an electroanalytical imaging device 400, in accordance with an embodiment. As shown, the electroanalytical imaging device 400 has an electroanalytical cell 402, an electroanalytical acquisition unit 404 and a computer 406. The electroanalytical cell 402 has a substrate 408 and a high-density miniature (MEA) 410 of electrodes 412 mounted on the substrate 408. The MEA 410 can be used to produce images from the electrodes 412 via electroanalytical methods; they are thus referred to as “electrochemical pixels 412”. The MEA 410 was based on multi-layer PCT due its good mix of spatial resolution, scalable footprint and low prototyping costs relative to competing technologies such as CMOS or photolithography-based fabrication methods. The exposed surfaces of the electrodes 412 were modified in a straightforward and economical way to improve their longevity and integration into microchannels. A customized, low-noise multiplexer (MUX) 430 was built, which enabled sequential addressing of the electrodes 412 controlled by a commercial potentiostat 432. Finally, a user-friendly analysis routine was developed to treat and display the large volumes of data that were generated. As a proof-of-principle, laminar flow streams of different redox solutions were imaged. A method for improving the spatial resolution to approximately 25 μm, which is more than 10 times smaller than the electrode size, was also demonstrated.

### Experiment of Example 1

In this example, the analyte solutions included potassium ferricyanide(III) (K₃Fe(CN)₆) and hexaammineruthenium(III) chloride (Ru(NH₃)₆Cl₃) (Sigma Aldrich, Canada) with ionic strength and pH adjustments made using NaCl (sodium chloride monobasic) and KCl and KOH (Sigma Aldrich, Canada), respectively. Ultrapure water (18.1 MΩcm⁻¹) was used for all aqueous solutions such as the confinement solutions.

The electrodes 412 were implemented on a substrate provide in the form of a custom-built multilevel PCB, arranged into a 10×20 array 410, as shown in FIG. 8. The PCB (Advanced Circuits, USA) was designed in-house using PCB design software (Altium Designer, Altium, USA). The electrodes 412 were produced as 340 μm×340 μm square shapes with an outer surface of gold, plated on nickel and copper substrate layers.

The electroanalytical cell 402 has three inlets 460a, 460b and 460c which enable flow confinement of chemical or biological materials. The y and x-directions are downstream and cross-stream, respectively. Control electronics 434 are provided and are connected to the potentiostat 432 and the custom-built MUX 430, which coordinated sampling of individual electrodes (xᵢ,yᵢ) 412 via connecting leads 418. In this experiment, a computer program and custom-made macros running on a standard PC 406 controlled the data acquisition process and data transfer, data management and visualization from the electroanalytical acquisition unit 404.

FIG. 9. shows a sectional view of the electroanalytical cell 402, in accordance with this experiment, showing connections of four electrodes 412 and their internal/external metal leads 418 in a four layer substrate 408. An insulation layer 462 is also provided. Composite electrode materials, connector assembly and complex routing geometries of internal leads for the entire MEA of 200 electrodes are not shown. Schematic is not to scale.

The electroanalytical cell 402 was designed in-house and fabricated commercially. A four-layer design was used to give higher electrode density because leads could be stacked over each other at different levels. Vias were covered and insulated in order to handle electrode connections and cross-section routing to avoid liquid leakage and to prevent electrical signal interference as they were submerged in the solution with electrode 412.

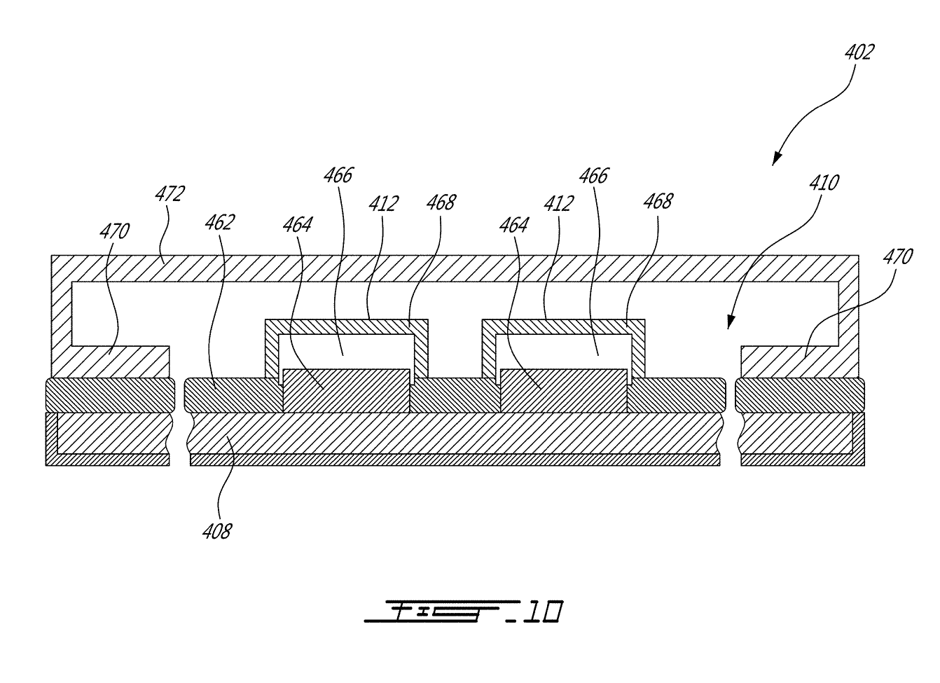

FIG. 10 shows a partial cross-section showing preparation of two electrodes 412 of the electroanalytical cell 402. The substrate 408 containing electrical connections (cross-hatched) is covered by protective epoxy 462, except where electrodes 412 protrude. After stripping the copper electrode contact pads 464 are exposed. After electrodeposition of a Ni layer 466 followed by an Au layer 468. A thin layer of PDMS 470 (approximately hPDMS=50 μm) is patterned around the MEA 410 (red cross-hatch) by spin coating, with the electrodes 412 remaining bare thanks to a removable adhesive barrier that was removed after the process. A PDMS channel 472 with a height k_{chan}=50 μm is adhered to the PDMS base-layer 470 by plasma activation. The total channel height after bonding was h_{PDMS}+h_{chan}=100 μm.

The gold layer as received from the manufacturer was prone to failure after a few cyclic voltammetry (CV) cycles. This was attributed to the thickness of the plating layer of just 10s of nm. Electrode failure was marked by non-reproducible CV curves and a change in colour of the electrode surface, likely due to oxidation and partial erosion of the thin gold layer.

To make the electrodes more robust and longer-lasting, their surfaces were reconstituted. To begin, the original plated materials were stripped by 1 M HCl and then electroplated with the layer of Ni 466, followed by the layer of Au 468. This was accomplished by the reduction of Ni and Au ions, respectively, using the parameters listed in Table 1 below. As noted in this table, two methods of Au plating were used. In the first, the plating solution listed in (a) was synthesised, whereas for the second (b), a commercial plating solution was used. As described in the main paper, following electrodeposition, CV measurements were conducted for up to two months without electrode compromise. In addition, the electrodes 412 were stable as pseudoreference electrodes with no noticeable drift detected in CV signals during their use. Following the process described in the main paper, the MEA 410 was then integrated into the microchannel, forming the sealing layer of the channel 472.

TABLE 1
Chemical bath conditions and deposition rate for electroplating of Ni and
Au electrode finishing layers.

| | Ni | Au method (a) | Au method (b) |
|---|---|---|---|
| Chemical bath | Ni(SO3NH2)24H2O 1.23M | HAuCl4 0.06M | Commercial plating |
| | NiCl26H2O 0.08M | Na2SO3 0.42M | solution |
| | H3BO3 0.48M | Na2HPO4 0.03M | |

| | | |
|---|---|---|
| Temperature (° C.) | 20 (with agitation) | 20 (with agitation) |
| Time (min) | 25 | 60 |
| pH | 3.6 | 6 |
| Potential (mV vs. Ag/AgCl) | −400 | −300 |
| Current density (A/cm2) | 0.005 | 0.005 |

The electrode reconditioning was done by electrodepositing Ni from a solution containing nickel sulfonate and nickel chloride (VWR, Canada). Gold electrodeposition was achieved using a chloroauric acid solution (254169, Sigma Aldrich, Canada) or a commercial gold plating solution (Gold Tank Plating Solution, Caswell Inc., USA).

A mould for the three inlet, co-flow design was made using a 50 μm thick dry photoresist film (Photopolymer film 50 μm, Mungolox, Germany) that was adhered to a glass slide using a laminator (L125A4, Fellowes, USA) and then selectively cross-linked by UV light (416-X, Mgchemicals, Canada) through a shadow mask. Uncross-linked portions of the photoresist were then removed using a developer solution provided with the photoresist. All microfabrication steps were accomplished outside of a cleanroom. Once the master mould was ready, the microchannel was formed by casting polydimethylsiloxane (Sylgard184, Dow corning, Canada) against it. To enhance bonding between the PDMS device and the PCB, a thin layer of PDMS was applied to the surface of the PCB by spin coating 4 mL of PDMS/cross-linker solution (10:1 ratio) at 3000 rpm for 2 minutes, while protecting the MEA 410 with an adhesive membrane. After heating (70° C.) for 4 hours, the adhesive membrane was removed, re-exposing the MEA 410. The resulting PDMS membrane was measured to be 50 μm thick and was well-attached to the PCB. The PDMS channel could then be strongly adhered to the PDMS film-coated portion of the PCB after air plasma activation of both surfaces (PCD-001, Harrick Plasma, Ithaca, USA) for 90 seconds at 600 mTorr. In the final device, the integrated PCB MEA became the sealing layer for the PDMS device. It also included external electrode connection points.

All flow simulations were conducted in two-dimensions using COMSOL Multiphysics® software with a fine mesh and physics for laminar flow and transport of dilute species in an incompressible fluidic phase. Molecular diffusion of ferro/ferricyanide molecules was simulated using the diffusion coefficient D_{ferro/ferri}=7.0×10⁻⁶ cm² s⁻¹, which was the average of the reported values for ferrocyanide and ferricyanide (D_{ferro}=7.3×10⁻⁶ cm² s⁻¹ and D_{ferri}=6.7×10⁻⁶ cm² s⁻¹, respectively).

Referring back to FIG. 8, leads 418 from the custom-built MUX 430 were connected to the MEA 410 via connection pins in the PCB. The MUX 430 was custom-built featuring mechanical relays (SPST 500MA 5 V, Coto Technology, USA) for low-noise via physical disconnection. The maximum configured switching frequency and peak voltage were 500 kHz and ±2 V, respectively. The data acquisition process was fully software controlled (Versastudio, Princeton Scientific Research, USA) by a macro routine which controlled the single channel potentiostat 432 (Versastat 450, Princeton Scientific Research, USA) and onboard input/output ports. The macro looped between (i) transmission of a control word from the potentiostat TTL outputs to a data converter module onboard the MUX 430, to select working (WE), reference (RE) and counter electrode (CE) combinations; (ii) initiation of a CV measurement and (iii) data handling. Following acquisition, a separate Matlab routine was applied and displayed a 2D MEC image. Flow control was achieved using syringe pumps 474 (PHD 2000, Harvard Apparatus, Holliston, Mass., USA) housing syringes (BD Scientific, NJ, USA), which were connected to the MECI platform via a 1.6 mm outer diameter perfluoroalkoxy (PFA) tubing (U-1148, IDEX, WA, USA), with appropriate connectors (P-200x, P-658, IDEX, WA, USA).

### Results of Example 1

Basic validation experiments included a comparison of the CV curves for gold REs vs. standard Ag/AgCl, trends of current (I) vs. the square root of the scan rate (V/s)1/2, the effect of solution flow velocity (v) on I and preliminary measurements demonstrating improvements to RMS noise vs. CE surface area.

The upper scan range of 50 mV for all CVs was selected for three reasons. First, the current at 50 mV, was sufficiently far from the anodic peak that the current had become adequately diminished such that the peak value of current could be determined for all analyte concentrations (refer to FIGS. 12B and 12C). Furthermore, the peak intensity was monitored, not the integrated intensity, so no information was lost. The second reason was to reduce the data acquisition time, which was relatively long because the measurement had to be conducted sequentially for all 200 electrodes in the MECI system.

The third reason was because the mentioned non-faradic background disproportionately affected the high values of applied potential.

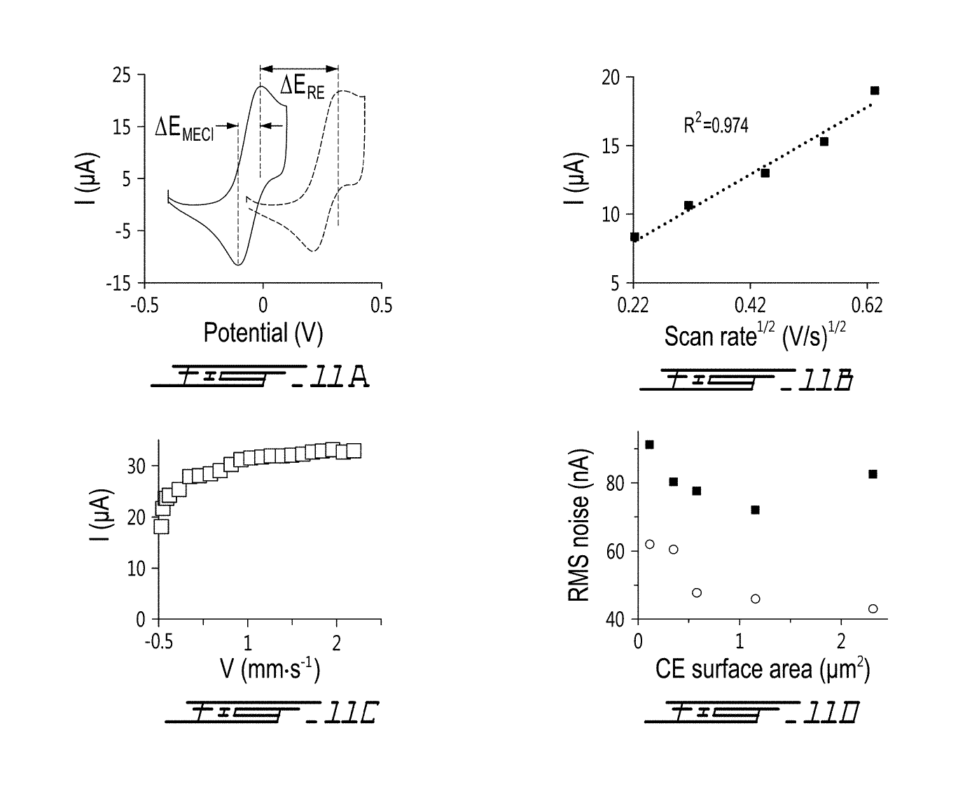

FIG. 11A shows raw CV curves (i.e. electroanalytical measurements) collected from a single gold WE using Ag/AgCl (dashed) and gold (solid) acquired in a 10 mM Fe(CN)6 3-solution at 100 mV·s−1. FIG. 11B shows anodic current vs. square root of scan rate and linear fit for a static 6 mM Fe(CN)6 3-solution confined in the MECI device. FIG. 11C shows anodic current of a 10 mM Fe(CN)6 3-solution (100 mV·s−1) vs. velocity. FIG. 11D shows signal to noise with changes to overall CE surface area. Areas were calculated from the use of 1, 3, 5, 10 and 20 CEs in total. Points corresponded to the Fe(CN)6 3-/4-solutions were 0.8 mM (o) and 10 mM (▪) concentrations.

The basic functionality of the electroanalytical imaging device 400 was validated which required calibration measurements for quantitative imaging of streams of potassium ferricyanide. In aqueous solution this salt dissociates into Fe(III)-containing Fe(CN)₆³⁻, which can be reversibly reduced to Fe(II)-containing ferrocyanide, Fe(CN)₆⁴⁻, as is shown in equation (1):

Fe(CN)₆³⁻+e⁻ [symbol] Fe(CN)₆⁴⁻E⁰=0.19 V (1)

CV measurements for potassium ferricyanide solutions were undertaken in the range from −400 mV to +0.50 mV. First the CV measurements from the MEA 410 embedded in the electroanalytical imaging device 400 were compared using a gold pseudo RE and a standard macroscopic Ag/AgCl RE. The latter measurement was accomplished by disassembling the MECI device and building an open faced cavity into which the exposed MEA could be bathed and the RE could be inserted. Typical raw CV curves for solutions containing Fe(CN)₆³⁻ were compared, as shown in FIGS. 11A-D. For the same concentration (10 mM), the curves were similar including having the same peak heights; however a shift, ΔE_{RE}, of approximately −330 mV±5 mV was due to the differences in REs. Nevertheless, the stability of the reconstituted gold electrodes resulted in very similar shifts for all electrodes over an evaluation period of more than 4 months. This meant that any electrode 412 in the MEA 410 could be used as the RE and maintains accurate correlation with the Ag/AgCl standard. A difference was noted between the oxidation potential (Eₒₓ=−10 mV) and the reduction potential (E_{red}=−105 mV) of ΔE_{MECI}=95 mV. This is good compared to other reported values, but indicated that the ohmic drop in the system may not be negligible, despite the compact nature of the MEA 410. A nearly linear relationship (R²=0.974) between the CV peak intensities and the square root of the scan rate was measured, as predicted using Randles-Sevcik diffusion-limited Faradaic currents, as shown in FIG. 11B. The CV current grew rapidly as the solution velocity was initially increased from v=0 mm s⁻¹ to a levelling off near v=1 mm s⁻¹, as shown in FIG. 11C. Therefore, results of this experiment were obtained at velocities greater than 1 mm s⁻¹. Residual variations in I with velocity should be eliminated by the calibration process discussed in the next section. Increasing the number of CEs led to improvements in the S/N ratio, but this parameter was not optimized, as shown in FIG. 11D. All experiments in this example used a ratio of 4:1 for the number of CEs:WEs. To test the electrode durability, the channel was rinsed and then stored in water-filled channels. It was discovered that the CV curves were repeatable by tests at least once every three days for two months, in this example. After this period, the signal quality degraded and some electrodes became inactive. The MEA 410 then had to be removed from the microchannel and reconditioned as discussed earlier.

Automated data treatment and analysis of CVs from each WE were conducted by using Matlab. FIG. 12A shows CV curves (electroanalytical measurements) from 0 mM (dashed), 0.6 mM (black) and 4 mM (blue) Fe[[(CN)]₆]³⁻ solutions with a scan rate of 100 mV ŝ(−1). FIG. 12B shows a CV curve for the 0.6 mM Fe[[(CN)]₆]³⁻ solution in FIG. 11A after background (dotted) and baseline subtractions (black) using the baseline shown (dashed). FIG. 11C shows CV curves from a single electrode (x₄, y₂) acquired from solution concentrations [Fe[[(CN)]₆]³⁻]: 2 mM, 4 mM, 6 mM, 8 mM, and 10 mM. FIG. 11D shows a calibration curve using peak currents from CV curves in FIGS. 11B and 110. The flow rate of analyte solution was 8 mL h⁻¹ in these cases.

Each CV curve was corrected by subtraction of a pre-collected 0 mM background curve. For example, in FIG. 12A the CV curves from the 0.6 mM and 4 mM solutions are superimposed on top of the 0 mM (background) solution. Even in the case of the 0.6 mM solution, which was difficult to distinguish from the background, a well-resolved peak was obtained (FIG. 12B) after subtraction. After baseline correction of the anodic current the resulting Faradaic-only anodic peak height was quantitatively related to the analyte concentration (FIG. 12B). FIG. 12B shows background and baseline corrected CV curves collected at a single WE in the presence of Fe(CN)₆³⁻ concentrations ranging from 0.6 mM to 10 mM. FIG. 12B shows that a calibration curve, f (xᵢyⱼ) (μA mM⁻¹), could be obtained from the linear fit of the CV peak currents, I(xᵢyⱼ) (μA), versus known concentrations, C (mM). To reduce the experimental time, the f(xᵢyⱼ) values could be obtained from as few as two I vs. C measurements. The calculated f(xᵢyⱼ) represented a unique conversion factor for each WE. This enabled comparable localized concentration measurements using equation (2):

C=I(xᵢyⱼ)/f(xᵢyⱼ) (2)

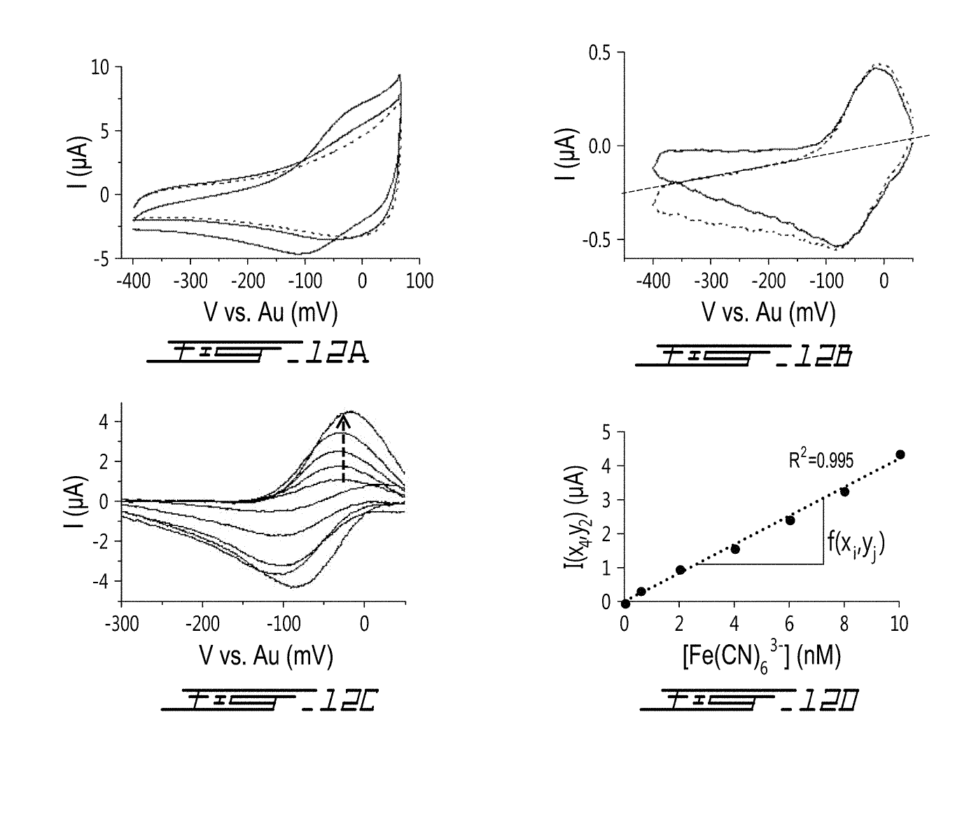

It was critical to determine f (xᵢyⱼ) independently for each WE because their values varied, likely due to differences in surface structuring due to the reconditioning process. The range of calibration slopes is the result of electrode-to-electrode variation, likely in their nanostructure. These results, as plotted in the histogram of FIG. 13, demonstrate the need for individual calibration curves for each electrode.

Using the electroanalytical imaging device, a Fe(CN)₆³⁻ analyte stream (inlet 460b) was confined between two inert solution streams (inlets 460a and 460c).

A chemical map was constructed, pixel-by-pixel, from the measured CV currents at each WE in the MEA 410. The time to acquire one image depended on the acquisition parameters. For CV, scanning the range of −400 mV to 50 mV at 100 mV s⁻¹ took approximately 30 minutes (450 mV×2 divided by 100 mV s⁻¹ for one complete cycle, multiplied by 200 for all WEs). However, the time can be reduced to just under 2 minutes by conducting linear voltammetry (50% reduction of time) in the range from −150 mV to 50 mV (56% reduction of time) at a scan rate of 400 mV s⁻¹ (75% reduction of time). Higher scan rates should also improve signal quality (i.e., better S/N).

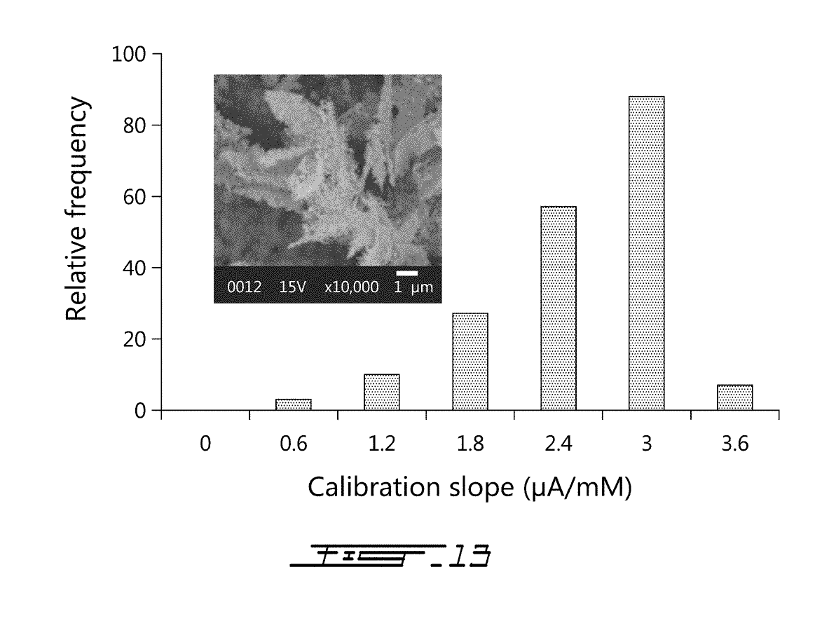

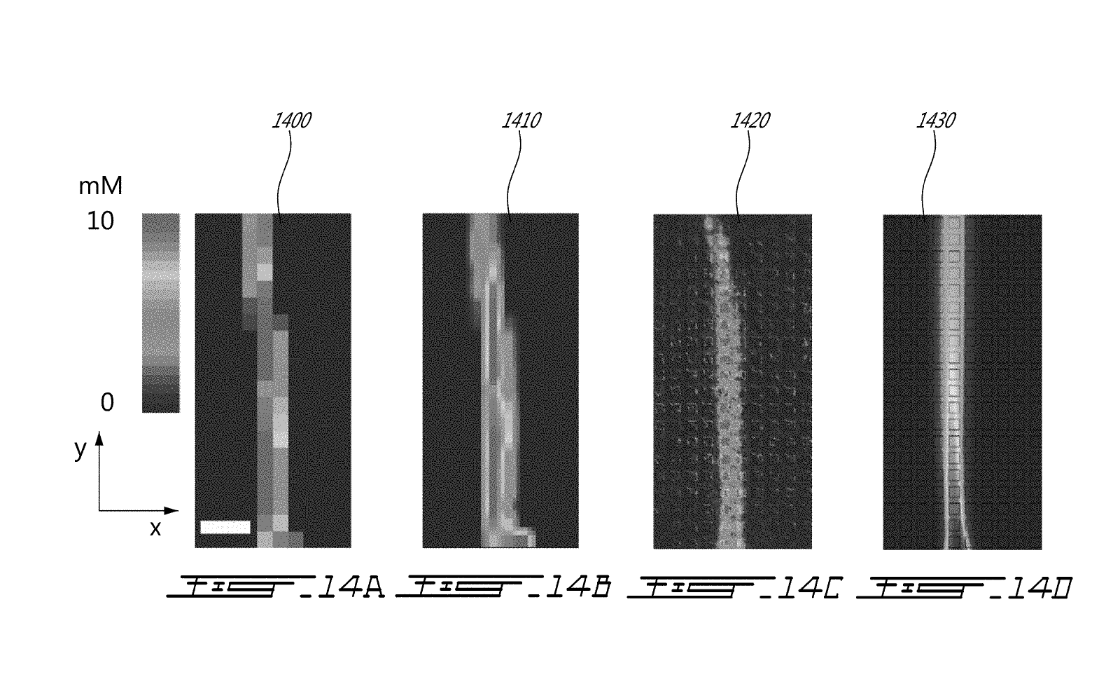

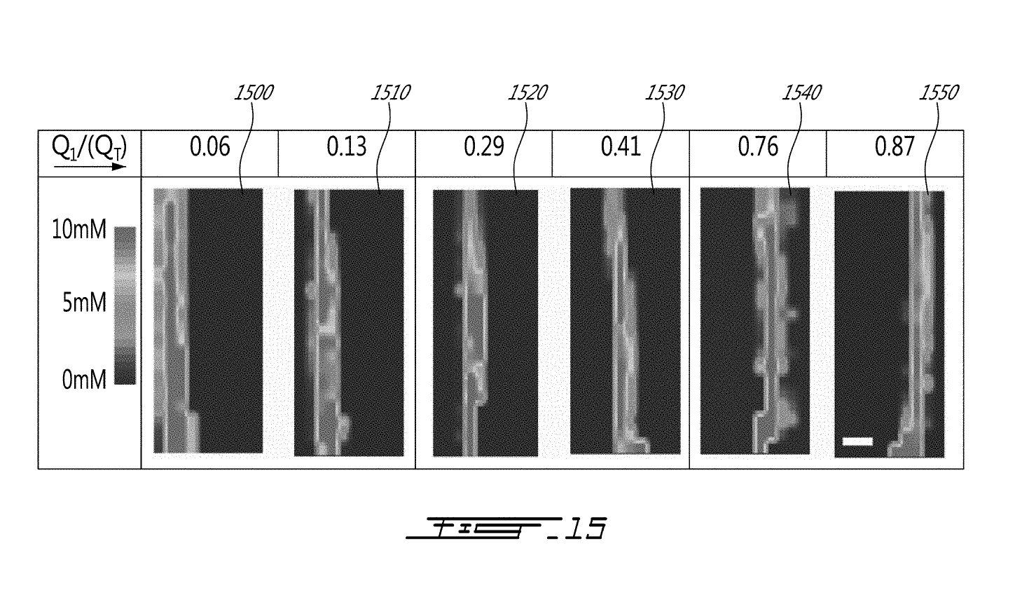

FIG. 14A shows such an electrochemical image 1400, obtained with a 10 mM Fe(CN)₆³⁻ solution flowing at Q₂=2.5 mL h⁻¹, with confinement flows Q₁=7.3 mL h⁻¹ and Q₃=10.7 mL h⁻¹. Individual pixel intensities were obtained from CV curves acquired in the range of −400 mV to 50 mV at 100 mV ŝ(−1). FIG. 14B shows a smoothed image 1410 obtained by applying a smoothing algorithm to the original electrochemical image 1400 to account for concentration gradients between electrodes 412. The electrochemical image 1400 closely resembled the results obtained from simulation and optical imaging. FIG. 14C shows an optical image 1420 thereof and FIG. 14D shows the result of a computer simulated image 1430 of the position of the flow stream under the same flow conditions as in FIG. 14A. A small amount of dye was added to the analyte solution while acquiring the optical image 1420 for visualization. The electrodes appear brighter in the optical image 1420 because of their relative reflectivity compared to the surrounding PCB materials.

Next a confined stream of the redox solution was swept across the channel cross-section by manipulating the ratio of the first confinement stream flow rate (Q₁) to the total confinement flow rate (Q_{T}=Q₁+Q₃=18 mL h⁻¹) in the range 0.06<Q₁/Q_{T}<0.87. The flow rate of the central redox solution was kept constant at Q₂=2.5 mL h⁻¹. In order to ensure that the flow streams had stabilized before the imaging started, 5 minutes were elapsed after the flow rates Q₁ and Q₃ were changed, to allow steady flow to settle. FIG. 15 shows electrochemical images 1500, 1510, 1520, 1530, 1540 and 1550 from a 6 frame video acquired under specified flow conditions (see Q₁/Q_{T} ratios indicated therein), which matched the computer simulation and optical imaging that were run in parallel (not shown).

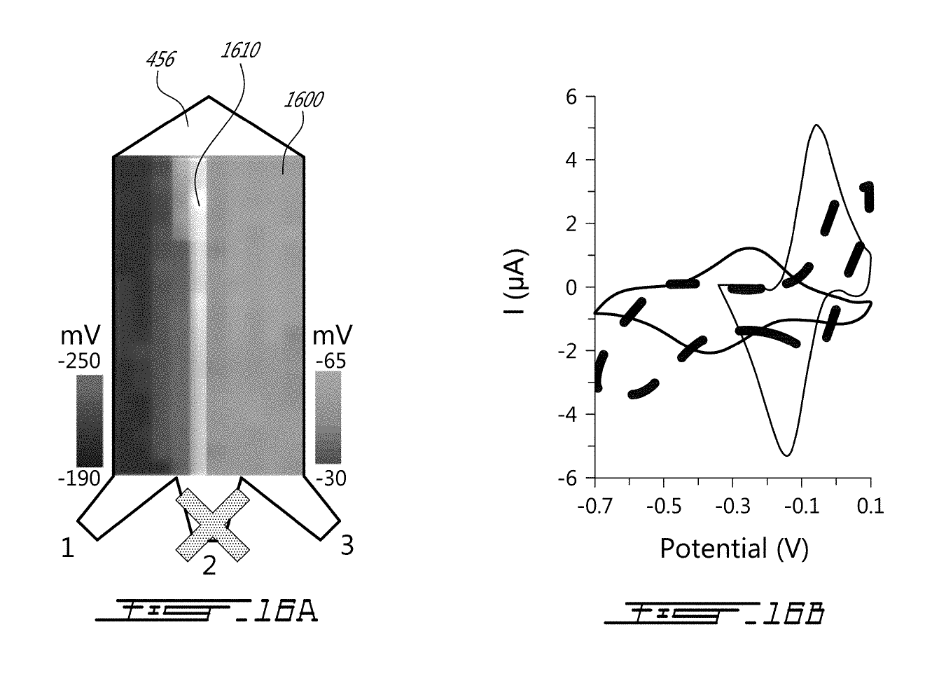

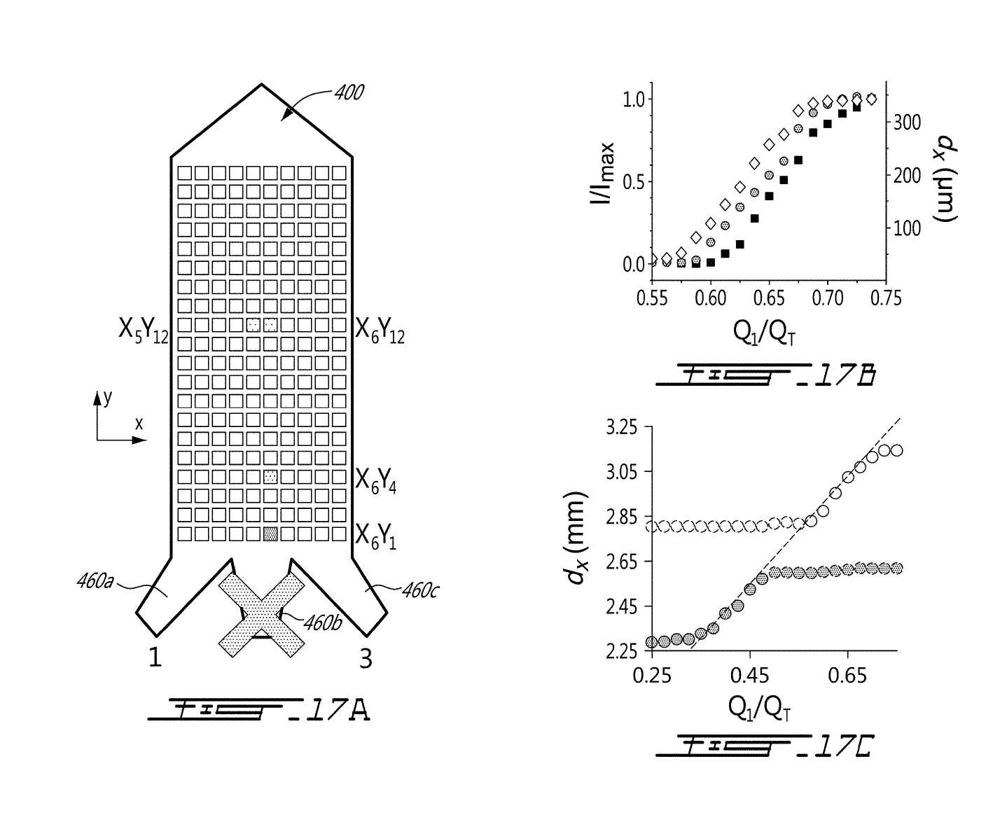

As described with reference to FIGS. 16A and 16B, the electrochemical imaging device 400 was tested to see if it was able to discriminate between two different analytes by flowing redox solutions of 10 mM Fe(CN)₆³⁻ and 5 mM hexaammineruthenium (Ru(NH₃)₆³⁺) side-by-side. In this experiment, the total flow rate was reduced to 1.5 mL h⁻¹ in order to encourage intermixing between the two streams for monitoring both separated and mixed solutions. FIG. 16A shows a composite image 1600 consisting of the oxidation peak potentials for Ru(NH₃)₆³⁺ and Fe(CN)₆³⁻, which are located near −250 mV and −40 mV, respectively. A white band 1610 between them shows an overlapping region. Individual chemical maps of the two streams show that the overlap region is wider near the outlet 456 due to longer diffusion times. It can be seen that the diffusion toward the Ru(NH₃)₆³⁺ side of the channel was more pronounced, likely due to the higher diffusivity of the Fe(CN)₆^{3-/4-} (7.0×10⁻⁶ cm² s⁻⁶) compared to the Ru(NH₃)₆^{3+/2+} (6.5×10⁻⁶ cm² s⁻¹). FIG. 16B shows representative CV curves which were generated in the two redox streams. Near the interface of the two streams two electrochemical effects were observed: a shift in the position in the redox bands and an increase in the ΔE. The formation of precipitation at the interface was also observed. These observations can be explained by a complexation between the Fe(CN)₆⁴⁻ and Ru(NH₃)₆³⁺ to form the insoluble complex (NH3₃)₅Ru(III)-μ(CN)—Fe(II)(CN)₅. Furthermore, the complexation should be thermodynamically spontaneous given that E_{cell}⁰=E_{cathode}⁰−E_{anode}⁰>0 from the reduction potentials (E⁰) of the two redox pairs in equation (1) and (3):

Ru(NH₃)₆³⁺+e⁻⇄Ru(NH₃)₆²⁺E⁰=−0.14 V (3)

Lastly, spatial resolution smaller than the size of individual electrodes 412 was obtained, as described above, by correlating changes in the measured electrode current to the fractional electrode coverage by the redox stream using equation (4):

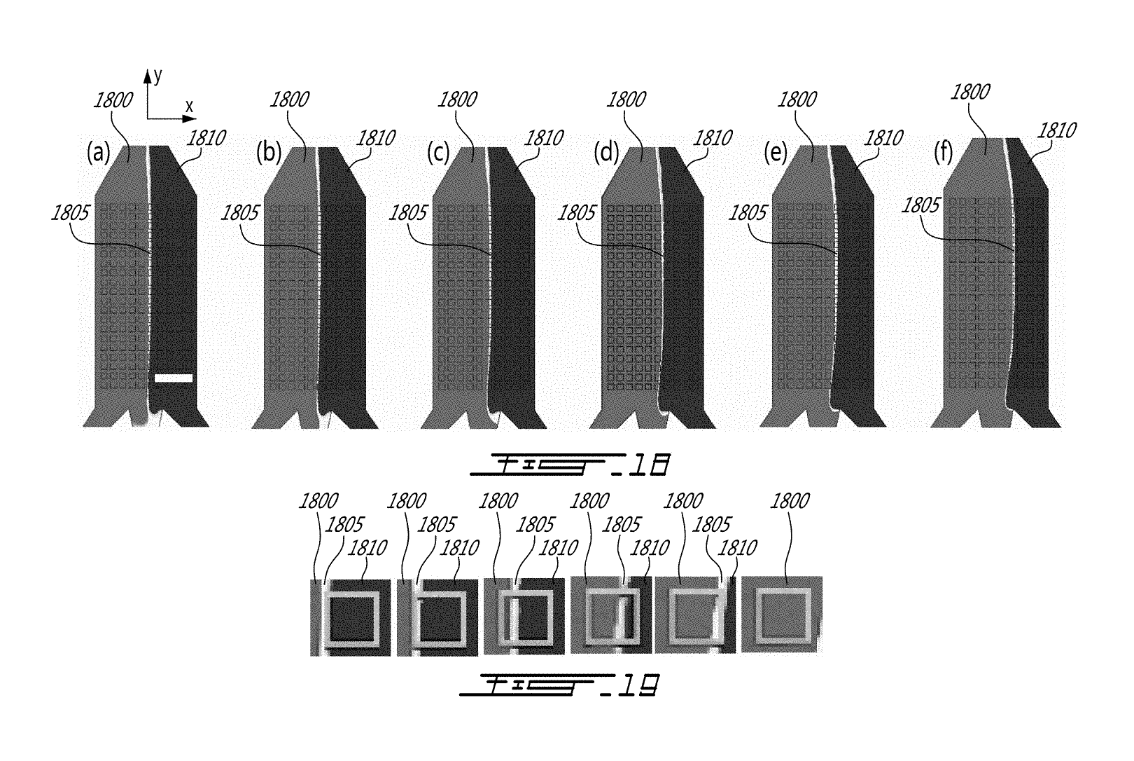

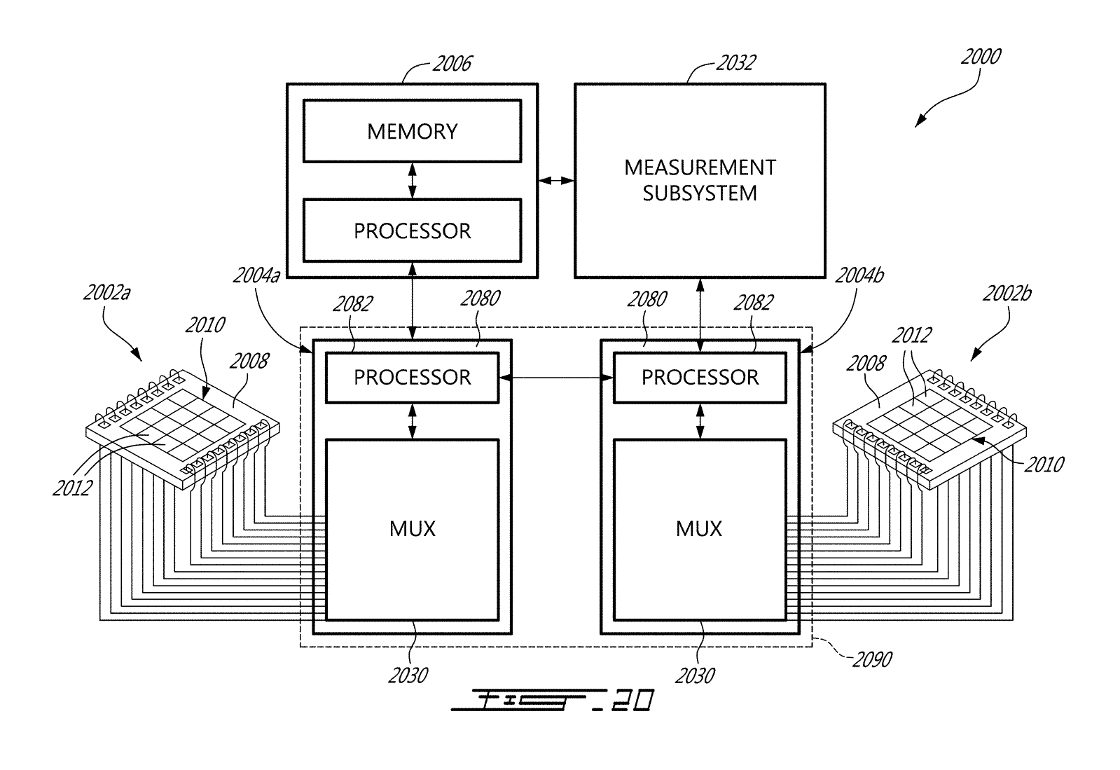

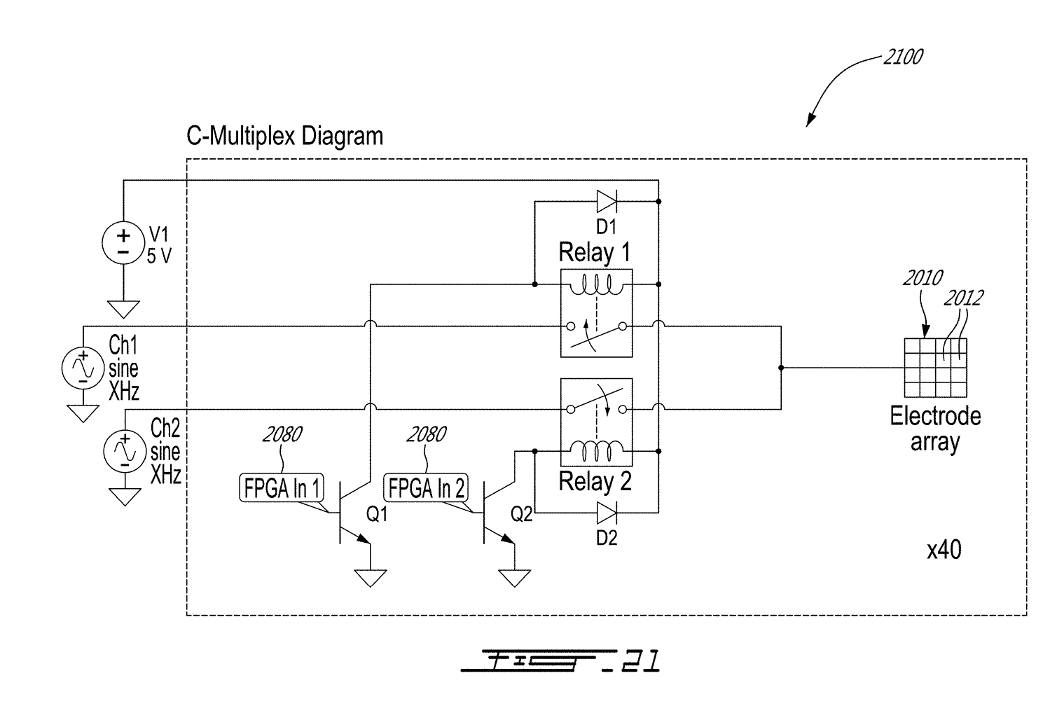

I(xᵢyⱼ)O=C·dₓ/w·f(xᵢyⱼ) (4)

where C is the known concentration of the prepared solution (10 mM), dₓ is the overlap distance between the analyte stream and the electrode in the x-direction and w is the width of an electrode (w=340 μm). For this approach to work, it was noted that the analyte concentrations should not change. Therefore, diffusional mixing should be minimized using sufficiently fast flow rates. As shown in FIG. 17A, two solutions (one analyte solution and the other a confinement solution) were introduced into the electroanalytical imaging device 400, a 10 mM Fe(CN)₆³⁻ solution through inlet 460a and a 0 mM confinement solution though inlet 460c, at volumetric flow rates Q₁ and Q₃, respectively. Inlet 460b was blocked (FIG. 17A). Therefore, the total flow rate was Q_{T}=Q₁+Q₃, which was kept constant (Q_{T}=8 mL h⁻¹). As is seen from a computer simulation, which the results are shown in FIGS. 18 and 19), increasing Q₁/Q_{T} displaced the flow stream interface in the x-direction toward the inlet 460c side of the electroanalytical imaging device 400. Also, the x-displacement was more noticeable at downstream y-positions. Using a variant of equation (4), FIG. 17B shows the calculated dₓ (equation (5)) from three electrodes in different y-positions within the same x=6 column (x₆y₁, x₆y₄, x₆y₁₂), while the flow rate ratio was changed in the range 0.55<Q₁/Q_{T}<0.75.

dₓ=A·I(xᵢyⱼ)/f(xᵢyⱼ) (5)

where A is a constant (34 mM⁻¹) resulting from w/C. At low Q₁/Q_{T} values all electrodes were fully immersed in the 0 mM solution and I(xᵢyⱼ) was 0. Step-wise increases in the flow rate ratio first resulted in increases in I(x₆y₁₂). This increase corresponded to about 5% of the maximum current for that electrode, or an overlap distance between the analyte stream and the electrode of dₓ=25 μm. As Q₁/Q_{T} was increased, the middle electrode (x₆y₄) was the next to become exposed to the Fe(CN)₆³⁻ solution, followed by the furthest upstream electrode (x₆y₁). Further increases in Q₁/Q_{T} resulted in nearly linear increases in dx for all electrodes. In this linear region, the difference in dx at y₁ and y₁₂ was measured to be approximately 150 μm, which was similar (about 30% less) to the prediction from the simulation. Deviations from linearity at the beginning and end of the curves in FIG. 17B were attributed to concentration gradients at the flow stream interface resulting from molecular diffusion. By extending this approach to all electrodes 412 in the same electrode column (x₁), a high resolution map can be constructed for the interface between the two flow streams.

Equation (6) is a modification to the approach above, which was used to observe the displacement of the analyte stream across electrodes over multiple x-columns.

dₓ=i·(A+s)·I(xᵢyⱼ)/f(xᵢyⱼ) (6)

where i is the x-column number and s is a constant (20 μm mM⁻¹) that accounts for the space between electrodes (200 μm). FIG. 17C shows the calculated change in dx across two electrodes in the same horizontal row (y₁₂) corresponding to Q₁/Q_{T}-dependent changes in I(x₅y₁₂) and I(x₆y₁₂), respectively. An initial rise in dₓ was observed in electrode X₅y₁₂, which was the first to be exposed to the analyte stream at low values of Q₁/Q_{T}. Further increases in Q₁/Q_{T} eventually resulted in a linear rise in dₓ.

Shortly after I(x₅y₁₂) reached a maximum current, indicating full immersion in the analyte stream, and I(x₆y₁₂) began to increase linearly. A plot of the two curves on the same graph shows a continuous change in the analyte stream location as it is driven across both electrodes with missing information between x=2.6 mm and x=2.8 mm, which corresponds to the 200 μm space between electrodes.

The change in the interface position was modeled between a redox and non-redox stream using Comsol (see experimental section in the main paper for more details) and compared it with current resulting from partial coverage of the electrode in FIG. 17B using equation 4. In the simulation, in response to progressive changes to the flow rate ratio, the interface between the two streams changed its position (see FIGS. 18 and 19). The flow rate ratio was defined as the volumetric flow rate of the redox solution (QR) divided by the total flow rate Q_{T}, where Q_{T}=QR+Q_{PBS}.

More specifically, FIG. 18 shows results of numerical simulations showing the displacement of redox and non-redox streams 1800 and 1810 and their interface 1805 under different flow rate ratios (QR/QT) 0.52 (a), 0.56 (b), 0.60 (c), 0.65 (d), 0.68 (e) and 0.75 (f). Where QT=8 mL·h−1 for all cases. Scale bar in (a) is 2.0 mm. Individual electrodes are shown as squares.

FIG. 19 shows a close up of an electrode (e.g., electrode x₆y₁ (see black electrode in FIG. 17A) as it is progressively exposed to greater surface coverage of the analyte solution (red) for the flow rate ratios (QR/QT) of: 0.52 (a), 0.56 (b), 0.60 (c), 0.65 (d), 0.68 (e) and 0.75 (f). Where QT=8 mL·h−1.

In this example, the concept of microfluidic-based electroanalytical imaging was demonstrated, and a specific example of a method of determining a proportion at which a given electrode is covered by the analyte solution was described. Using such a method, it was shown that spatial resolution could be as low as 25 μm for 340 μm by 340 μm electrodes. In some embodiments, it may be preferable to keep the inter-diffusion between flow streams as low as possible. The electroanalytical imaging device can be used for direct measurements of spatially isolated redox molecules in chemical and biological systems in some embodiments. These include surface diffusion of neurotransmitters and electron transport mechanisms in electroactive cells and biofilms by voltammetry or chronoamperometry, for instance. In addition, with the aid of in situ microscopy, new applications into electrogenerated chemiluminescence and ionchanneling in cells can be performed. The performance of the electroanalytical imaging device can be improved by optimizing: (i) the image acquisition time, (ii) the limit of detection, (iii) the enhanced spatial resolution, and (iv) the electrode stability against oxidation for better longevity and wider voltage sweep ranges. In some cases, the parameters (i) through (iv) may be addressed by (i) undertaking parallel electrode measurements and increasing scan rates; (ii) optimizing electrode surface nanostructuring, applying different voltammetry methods such as DPV, analyzing cathodic current peaks in addition to the present analysis of anodic ones, increasing scan rates and optimizing number or placement of CEs; (iii) reducing electrode size and increasing their density via increases in PCB layering depth or optimizations of electrode configurations; and (iv) modification of the process for adding resilient gold surfaces to electrodes via higher quality electrodeposition solutions or different techniques.

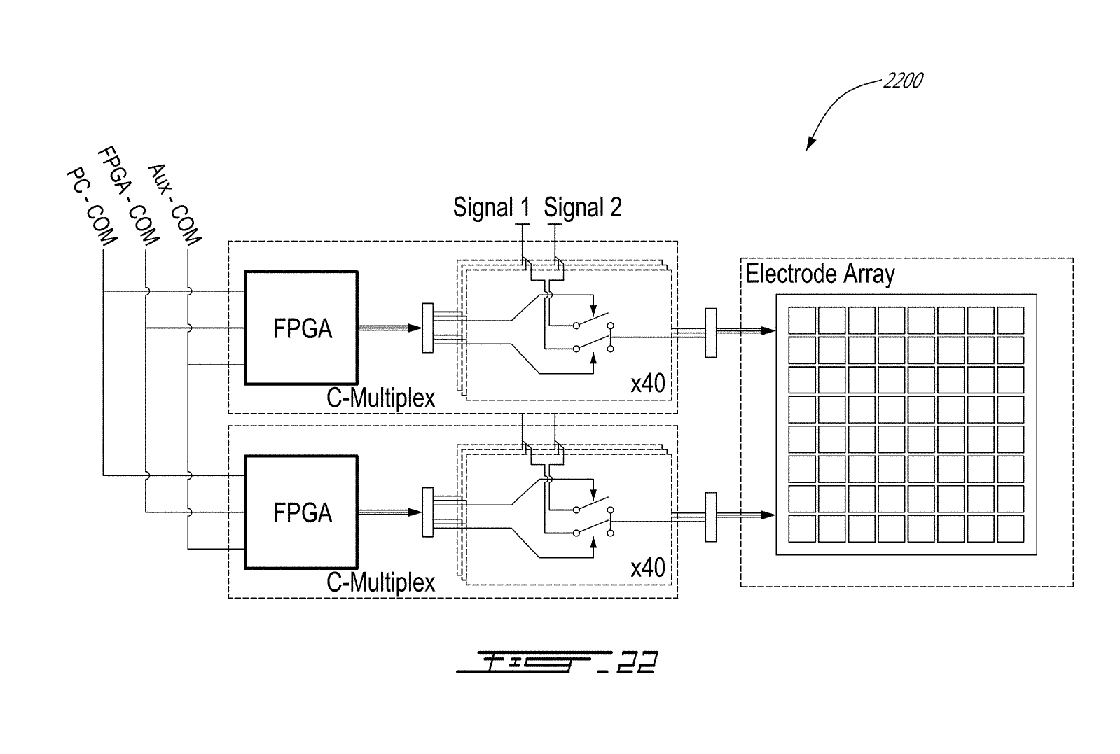

FIG. 20 is a schematic view of an example of a modular electroanalytical imaging device 2000 incorporating two electroanalytical cells 2002a and 2002b connected to a respective one of two electroanalytical acquisition modules 2004a and 2004b, in accordance with an embodiment. As depicted, each electroanalytical cells 2002a, 2002b has a substrate 2008 and an array 2010 of electrodes 2012a, 2012b mounted on the corresponding substrate 2008. Each electroanalytical acquisition modules 2004a, 2004b has a substrate 2080, a multiplexer subsystem 2030 mounted on the substrate 2080, and a processor 2082 mounted on the substrate 2080 and communicatively coupled to the multiplexer subsystem 2030. As can be seen, the multiplexer subsystem 2030 of the two electroanalytical acquisition modules 2004a and 2004b are removably connected to the electrodes 2012 of a corresponding one of two electroanalytical cells 2002a and 2002b. A measurement subsystem 2032 is communicatively coupled to the electrodes 2012 of the two electroanalytical cells 2002a and 2002b in view of their respective connection to the multiplexer subsystem 2030 of the two electroanalytical acquisition modules 2004a, 2004b. A computer 2006 is communicatively coupled to either or both of the processors 2080 such that it can produce a digital image based on electroanalytical measurements performed by the measurement subsystem between the connected electrodes 2012.

The modular electroanalytical imaging device 2000 is configured such that it can produce a digital image using the 32 electrodes 2012 of the two electroanalytical cells 2002a and 2002b when they are connected to their respective electroanalytical acquisition modules 2004a and 2004b, as shown in FIG. 20. However, the modular electroanalytical imaging device 2000 is also configured such that it can produce a digital image using the 16 electrodes 2012 of either one of the two electroanalytical cells 2002a, 2002b, depending which ones are connected to the computer via their respective electroanalytical acquisition modules 2004a and 2004b. In other embodiments, more than two electroanalytical cell and electroanalytical acquisition unit can be provided so that the electroanalytical imaging device 2000 can enable modularity.

In this example, the processors 2080 associated with the electroanalytical acquisition modules 2004a and 2004b are provided in the form of FPGA. However, in some other embodiments, the processors 2080 can be provided in the form of a microcontroller, a circuit or any other processor deemed suitable. As shown in FIG. 20, the substrate 2080 of the two electroanalytical acquisition modules 2004a, 2004b can be provided in the form of a single PCB board 2090 where the processor(s) 2082 are connected to the multiplexer subsystem(s) 2030 via conductive traces or wires of the PCB board.

FIG. 21 is a schematic view of a first example of a circuit 2100 connecting the processors 2080 of the two different electroanalytical acquisition modules with the array 2010 of electrodes 2012.

The circuit 2100 shows an example of a multiplexer subsystem (C-multiplex). It can offer 40 channels of 2:1 bi-directional analog multiplexing with real disconnect option and shared inputs. Its design can allow a high modularity and versatility. It can communicate and be controlled from the computer 2006 via a USB/Serial connection or a wireless connection. This communication can be managed via a LabView interface where each output is color coded according to its state which is easily manageable. Within this interface, the number of connected modules can be set to enable individual management of each C-Multiplex. C-Multiplex can communicate to other modules via 12C or custom communication protocol using its auxiliary ports. Those I/O pins can also be used to mount small auxiliary plug-n-play modules to connect the device with specialized equipment such as, but not limited to, potentiostats, signal generators, power supplies, Bluetooth adapter, syringe pumps, etc. The I/O pins can also be used as usable digital 3.3V outputs. The 40 channels are made from a configuration of relays. It offers a customizable pull-down load for each output, low cross-talk using ground lines between each output, low channel resistance [0.3 Ohms], high voltage capability [200 Vdc], high current capability [1 A/channel] (max(10 W/channel)) and high disconnect resistance [10̂10 Ohms minimum]. The circuit 2100 can be controlled by a modular FPGA board. The FGPA manages the communication between all connected devices (PC 2006 and other C-Multiplex modules or plug-n-play modules). The FPGA board contains 8 ADC channels that can be used if desired. The FPGA also manages the relay circuit in order to deal with transition delays. The FPGA manages the circuit according to the mode it's been set for since the device can be used in a few different ways. In the 40 2:1 mode, it offers 3 outputs type for each 40 channels: signal 1, signal 2 or disconnect. At any given moment, any number of the 40 outputs can be enabled on any of its 3 states. Signal 1 and signal 2 output types directly connect the output of the given electrode on the CH1 or CH2 input on the card. In the 40:2 mode, the card becomes a demultiplexer. The 40 outputs now become 40 inputs and the 2 inputs are now 2 outputs. In this mode, any one input can be connected to one of the 2 outputs channels. In the 1:40/40:1 mode, the card behaves both as a multiplexer and a demultiplexer. 40 outputs can be either disconnected, connected to signal 1 or connected to sensing on CH2. The C-Multiplex device can be used in a variety of applications such as microfluidics, digital microfluidics, electrochemistry, electrochemical imaging, multiplexing sensors, multiplexing electrodes, multi-motor drive, and pump drive. C-Multiplex modules can also be connected together to handle a large array. For example 2 C-Multiplex interconnected together can handle up to 80 electrodes. As each C-Multiplex has its own 2 inputs, all input (1) can be connected together and the same for input (2). Or user can keep them independent so that user can use an 80 electrode array with 4 input split into two 40 electrode sub array.

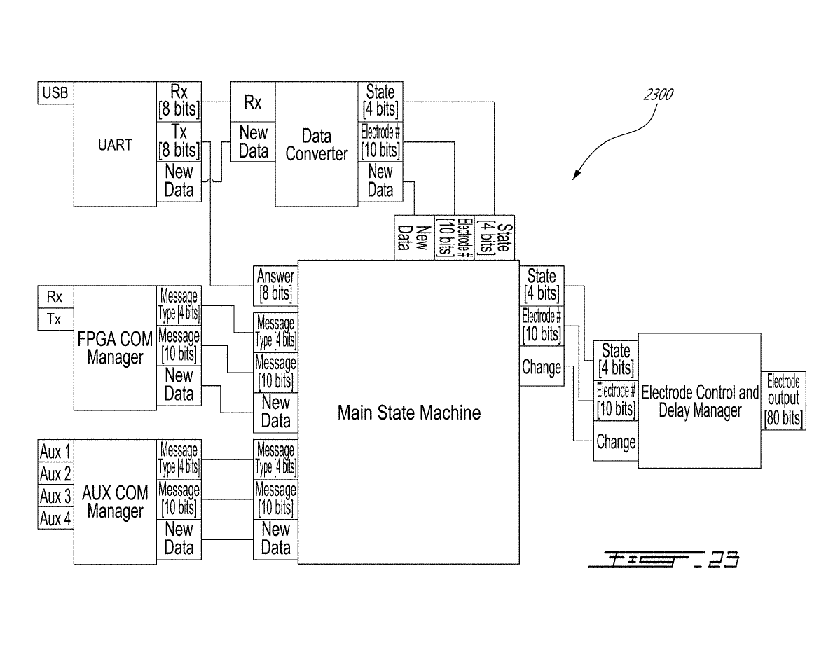

FIG. 22 is a schematic view of a second example of a circuit 2200 connecting processors 2080 of the two different electroanalytical acquisition modules with the array 2010 of electrodes 2012, in accordance with another embodiment. FIG. 23 is a schematic view of a hardware and software implementation 2300 of the modular electroanalytical imaging device 2000, in accordance with an embodiment.

As can be understood, the examples described above and illustrated are intended to be exemplary only. The scope is indicated by the appended claims.

What is claimed is:

1. A computer-implemented method for determining a proportion of a given electrode being covered by an analyte solution having a given concentration using an electroanalytical imaging device having an array of electrodes including the given electrode, the computer-implemented method comprising the steps of:
receiving a calibration value of a calibration electroanalytical measurement between the given electrode and at least one other electrode of the array when the given electrode is fully covered by a calibration analyte solution having the given concentration;
receiving a first value of a first electroanalytical measurement between the given electrode and at least one other electrode of the array; and
determining the proportion of the given electrode being covered by the analyte solution in the first electroanalytical measurement based on the first value and on the calibration value.

2. The computer-implemented method of claim 1 wherein said determining includes:
receiving a concentration value of the given concentration and a width value of the given electrode; and
determining an overlap distance between the analyte solution and the given electrode further based on the concentration value and the width value.

3. The computer-implemented method of claim 1 further comprising:
generating a digital image showing at least an image of the given electrode being covered by the analyte solution based on the determined proportion.

4. The computer-implemented method of claim 3 wherein said generating includes:
receiving an identifier identifying the given electrode from other electrodes of the array;
wherein the digital image shows the other electrodes of the array and the given electrode at its respective position in the array, relative to the other electrodes of the array, based on the identifier.

5. The computer-implemented method of claim 3 further comprising:
repeating the steps of the computer-implemented method of claim 1 for a plurality of electrodes adjacent the given electrode, thus obtaining a plurality of proportions at which respective ones of the plurality of electrodes adjacent the given electrode are covered by the analyte solution; and
wherein said digital image is generated based on the plurality of proportions.

6. The computer-implemented method of claim 1:
wherein said receiving a calibration value includes receiving an electroanalytical curve of the calibration electroanalytical measurement and assigning a maximal value of said electroanalytical curve as the calibration value; and
said receiving a first value includes receiving an electroanalytical curve of the first electroanalytical measurement and assigning a maximal value of said electroanalytical curve as the first value.

7. The computer-implemented method of claim 6 wherein the calibration and first electroanalytical measurements are voltammetry measurements and said electroanalytical curves are voltagramms.

8. The computer-implemented method of claim 1 wherein the given electrode is a working electrode of the array of electrodes and the at least one other electrode of the calibration and first electroanalytical measurements includes a reference electrode and a counter electrode of the array of electrodes.

9. The computer-implement method of claim 1, wherein the proportion is given by a ratio of the first value over the calibration value, wherein the proportion is 1 when the first value equals the calibration value and wherein the proportion is 0 when the first value is null.

10. An electroanalytical imaging device comprising:
an electroanalytical cell having a substrate and an array of electrodes mounted on the substrate;
an electroanalytical acquisition unit connected to the electrodes of the array and being configured for performing electroanalytical measurements between electrodes of the array; and
a processor communicatively coupled to the electroanalytical acquisition unit and being configured for:
receiving a calibration value of a calibration electroanalytical measurement between a given electrode of the array and at least one other electrode of the array when the given electrode is fully covered by a calibration analyte solution having a given concentration;
receiving a first value of a first electroanalytical measurement between the given electrode and at least one other electrode of the array; and
determining the proportion of the given electrode being covered by an analyte solution having the given concentration in the first electroanalytical measurement based on the first value and on the calibration value.

11. The electroanalytical imaging device of claim 10 further comprising a container having a wall having a bottom edge sealingly mounted to the substrate and exposing the array of electrodes for containing at least the analyte solution.

12. The electroanalytical imaging device of claim 11 wherein the wall has a top edge defining an opening leading to the array of electrodes, and a lid coupleable to a top edge of the wall for closing the opening.

13. The electroanalytical imaging device of claim 11 wherein the container is provided in the form of a channel, the channel having at least one inlet at a first end of the channel and at least one outlet at an opposite, second end of the channel, the channel defining a fluid path extending between the at least one inlet and the at least one outlet.

14. The electroanalytical imaging device of claim 13 wherein the channel is a microfluidic channel adapted to channel at least one flow of the analyte solution from the at least one inlet to the at least one outlet while the first electroanalytical measurement is performed.

15. The electroanalytical imaging device of claim 10 having a memory communicatively coupled to the processor for storing at least one of the calibration value, the first value and the proportion.

16. The electroanalytical imaging device of claim 10 wherein the electroanalytical acquisition unit includes a multiplexer subsystem being connected to the electrodes of the array; a measurement subsystem connected to the multiplexer subsystem; and control electronics for performing the electroanalytical measurements.

17. The electroanalytical imaging device of claim 10 wherein the electroanalytical cell is provided in the form of a printed circuit board.

18. A computing device for use with an electroanalytical imaging device having an array of electrodes, the computing device comprising:
one of i) a processor and a memory communicatively coupled to one another; and
ii) an electronic circuit;
the one of i) and ii) being configured for:
receiving a calibration value of a calibration electroanalytical measurement between a given electrode of the array and at least one other electrode of the array when the given electrode is fully covered by a calibration analyte solution having a given concentration;
receiving a first value of a first electroanalytical measurement between the given electrode and at least one other electrode of the array; and
determining a proportion of the given electrode being covered by an analyte solution having the given concentration in the first electroanalytical measurement based on the first value and on the calibration value.

19. A modular electroanalytical imaging device comprising:
a plurality of electroanalytical cells each having an array of electrodes;
a plurality of electroanalytical acquisition modules including
a substrate,
a multiplexer subsystem mounted on the substrate, and
a processor mounted on the substrate and communicatively coupled to the multiplexer subsystem, the multiplexer subsystem of at least one of the plurality of electroanalytical acquisition modules being connected to the electrodes of at least a corresponding one of the plurality of electroanalytical cells;
a measurement subsystem communicatively coupled to the connected electrodes via the corresponding multiplexer subsystem of the at least one of the plurality of electroanalytical acquisition modules; and
a computer communicatively coupled to at least one processor of the at least one of the plurality of electroanalytical acquisition modules and being configured to produce a digital image based on electroanalytical measurements performed by the measurement subsystem between the connected electrodes.
